(19) United States
(12) Patent Application Publication
(10) Pub. No.: US 2026/0268856 A1
(43) Pub. Date: Sep. 10, 2026

(54) DISPLAY DEVICE AND ELECTRONIC DEVICE

(71) Applicant: Samsung Display Co., Ltd., Yongin-si (KR)

(72) Inventors: Jae Hyung CHO, Yongin-si (KR); Il Nam KIM, Yongin-si (KR); Min Kyu WOO, Yongin-si (KR); Jae Yong JANG, Yongin-si (KR); Min Jae JEONG, Yongin-si (KR)

(21) Appl. No.: 19/397,002

(22) Filed: Nov. 21, 2025

(30) Foreign Application Priority Data
Mar. 5, 2025 (KR) 10-2025-0028256
Jun. 23, 2025 (KR) 10-2025-0082476

(51) Int. Cl. G09G 3/3266

(52) U.S. Cl. CPC G09G 3/3266; G09G 2300/0426; G09G 2300/0819

(57) ABSTRACT

The present disclosure relates to a display device, and more particularly, to a display device and an electronic device capable of reducing an area of a bezel. The display device includes: a display panel including a display area and a non-display area; a first gate driver located in the non-display area adjacent to the display area; an emission controller located in the non-display area adjacent to an edge of the display panel; a second gate driver located in the non-display area between the first gate driver and the emission controller; and a plurality of pixel power lines connected to pixels of the display area, wherein at least one of the plurality of pixel power lines overlaps at least one of the second gate driver or the emission controller.

### CROSS-REFERENCE TO RELATED APPLICATION

This application claims priority to and the benefit of Korean Patent Application No. 10-2025-0028256, filed on Mar. 5, 2025, in the Korean Intellectual Property Office and Korean Patent Application No. 10-2025-0082476, filed on Jun. 23, 2025, in the Korean Intellectual Property Office, the entire disclosures of which are incorporated by reference herein.

### BACKGROUND

### 1. Field

The present disclosure relates to a display device, and more particularly, to a display device and an electronic device capable of reducing an area of a bezel.

### 2. Description of the Related Art

An organic light emitting display device includes a display element of which luminance is changed by a current, for example, an organic light emitting diode (OLED).

### SUMMARY

Aspects and features of embodiments of the present disclosure provide a display device and an electronic device capable of reducing an area of a bezel.

According to one or more embodiments of the present disclosure, a display device including: a display panel including a display area and a non-display area; a first gate driver located in the non-display area adjacent to the display area; an emission controller located in the non-display area adjacent to an edge of the display panel; a second gate driver located in the non-display area between the first gate driver and the emission controller; and a plurality of pixel power lines connected to pixels of the display area, wherein at least one of the plurality of pixel power lines overlaps at least one of the second gate driver or the emission controller.

According to one or more embodiments, the plurality of pixel power lines includes a bias voltage line, a first initialization voltage line, a common voltage line, a second-first initialization voltage line, and a second-second initialization voltage line.

According to one or more embodiments, the second-first initialization voltage line overlaps the second gate driver, and wherein the second-second initialization voltage line overlaps the emission controller.

According to one or more embodiments, the bias voltage line, the first initialization voltage line, and the common voltage line overlap the first gate driver.

According to one or more embodiments, the bias voltage line overlaps the second gate driver, and wherein the first initialization voltage line overlaps the emission controller.

According to one or more embodiments, the common voltage line, the second-first initialization voltage line, and the second-second initialization voltage line overlap the first gate driver.

According to one or more embodiments, a pixel of the pixels of the display area includes: a pixel circuit connected to the bias voltage line, the first initialization voltage line, the common voltage line, a data line, and a second initialization voltage line; and a light emitting element connected to the pixel circuit and the common voltage line, wherein the second initialization voltage line is one of the second-first initialization voltage line and the second-second initialization voltage line.

According to one or more embodiments, the pixels of the display area include: a first pixel comprising a first light emitting element to emit first light; a second pixel comprising a second light emitting element to emit second light; and a third pixel comprising a third light emitting element to emit third light.

According to one or more embodiments, the second-first initialization voltage line is connected to the first pixel and the second pixel, and wherein the second-second initialization voltage line is connected to the third pixel.

According to one or more embodiments, the first light is light of a red wavelength band, wherein the second light is light of a blue wavelength band, and wherein the third light is light of a green wavelength band.

According to one or more embodiments, the display device further includes: a write high voltage line, a write low voltage line, a write start clock line, a first write clock line, a second write clock line, a third write clock line, and a fourth write clock line connected to the first gate driver; a bias high voltage line, a bias low voltage line, and a bias start clock line connected to the second gate driver; an emission high voltage line, an emission low voltage line, and an emission start clock line connected to the emission controller; and a common low voltage line, a first common clock line, and a second common clock line connected to the second gate driver and the emission controller, wherein the bias start clock line is connected to the second gate driver and the emission controller.

According to one or more embodiments, the write high voltage line, the write low voltage line, the write start clock line, the first write clock line, the second write clock line, the third write clock line, and the fourth write clock line overlap the first gate driver, wherein the bias high voltage line, the bias low voltage line, the bias start clock line, and the second common clock line overlap the second gate driver, and wherein the emission high voltage line, the emission low voltage line, the common low voltage line, the emission start clock line, and the first common clock line overlap the emission controller.

According to one or more embodiments, the emission low voltage line further overlaps the second gate driver.

According to one or more embodiments, the second-first initialization voltage line is located between the second common clock line and the bias low voltage line, and wherein the second-second initialization voltage line is located between the common low voltage line and the first common clock line.

According to one or more embodiments, the first gate driver includes a first write stage connected to a first write gate line of the display panel and a second write stage connected to a second write gate line of the display panel, wherein the first write stage includes a first write transistor, a second write transistor, a third write transistor, a fourth write transistor, a fifth write transistor, a sixth write transistor, a first write capacitor, and a second write capacitor, wherein the second write stage includes a fourth write transistor, a fifth write transistor, a sixth write transistor, a first write capacitor, and a second write capacitor, wherein the first write transistor of the first write stage includes a gate electrode connected to the fourth write clock line, a source electrode connected to the write start clock line, and a drain electrode connected to a write set node, wherein the second write transistor of the first write stage includes a gate electrode connected to the write set node, a source electrode connected to a write reset node, and a drain electrode connected to the fourth write clock line, wherein the third write transistor of the first write stage includes a gate electrode connected to the fourth write clock line, a source electrode connected to the write reset node, and a drain electrode connected to the write low voltage line, wherein the fourth write transistor of the first write stage includes a gate electrode connected to the write low voltage line, a source electrode connected to the write set node, and a drain electrode connected to a gate electrode of the fifth write transistor in the first write stage, wherein the fifth write transistor of the first write stage includes a gate electrode connected to the drain electrode of the fourth write transistor in the first write stage, a source electrode connected to one of the first to fourth write clock lines, and a drain electrode connected to the first write gate line, wherein the sixth write transistor of the first write stage includes a gate electrode connected to the write reset node, a source electrode connected to the write high voltage line, and a drain electrode connected to the first write gate line, wherein the first write capacitor of the first write stage is connected between the gate electrode of the fifth write transistor in the first write stage and the first write gate line, wherein the second write capacitor of the first write stage is connected between the write reset node and the write high voltage line, wherein the fourth write transistor of the second write stage includes a gate electrode connected to the write low voltage line, a source electrode connected to the write set node, and a drain electrode connected to the gate electrode of the fifth write transistor in the second write stage, wherein the fifth write transistor of the second write stage includes a gate electrode connected to the drain electrode of the fourth write transistor in the second write stage, a source electrode connected to another one of the first to fourth write clock lines, and a drain electrode connected to the second write gate line, wherein the sixth write transistor of the second write stage includes a gate electrode connected to the write reset node, a source electrode connected to the write high voltage line, and a drain electrode connected to the second write gate line, wherein the first write capacitor of the second write stage is connected between the gate electrode of the fifth write transistor in the second write stage and the second write gate line, and wherein the second write capacitor of the second write stage is connected between the write reset node and the write high voltage line.

According to one or more embodiments, the second gate driver includes a bias stage connected to a bias gate line of the display panel, wherein the bias stage includes a first bias transistor, a second bias transistor, a third bias transistor, a fourth bias transistor, a fifth bias transistor, a sixth bias transistor, a seventh bias transistor, an eighth bias transistor, a first bias capacitor, and a second bias capacitor, wherein the first bias transistor includes a gate electrode connected to one of the first common clock line or the second common clock line, a source electrode connected to the bias start clock line, and a drain electrode connected to a bias set node, wherein the second bias transistor includes a gate electrode connected to the bias low voltage line, a source electrode connected to the bias set node, and a drain electrode connected to a gate electrode of the fifth bias transistor, wherein the third bias transistor includes a gate electrode connected to the gate electrode of the fifth bias transistor, a counter gate electrode connected to the gate electrode of the fifth bias transistor, a source electrode connected to a bias reset node, and a drain electrode connected to the bias low voltage line, wherein the fourth bias transistor includes a gate electrode connected to the bias set node, a source electrode connected to the bias high voltage line, and a drain electrode connected to the bias reset node, wherein the fifth bias transistor includes the gate electrode connected to the drain electrode of the second bias transistor, a source electrode connected to the bias gate line, and a drain electrode connected to the bias low voltage line, wherein the sixth bias transistor includes a gate electrode connected to the bias reset node, a source electrode connected to the bias high voltage line, and a drain electrode connected to the bias gate line, wherein the seventh bias transistor includes a gate electrode connected to the gate electrode of the fifth bias transistor, a source electrode connected to a bias carry line, and a drain electrode connected to the common low voltage line, wherein the eighth bias transistor includes a gate electrode connected to the bias reset node, a source electrode connected to the bias high voltage line, and a drain electrode connected to the bias carry line, wherein the first bias capacitor is connected between the gate electrode of the fifth bias transistor and the bias gate line, and wherein the second bias capacitor is connected between the bias reset node and the bias high voltage line.

According to one or more embodiments, the emission controller includes an emission stage connected to an emission control line of the display panel, wherein the emission stage includes a first light emitting transistor, a second light emitting transistor, a third light emitting transistor, a fourth light emitting transistor, a fifth light emitting transistor, a sixth light emitting transistor, a seventh light emitting transistor, an eighth light emitting transistor, a first light emitting capacitor, and a second light emitting capacitor, wherein the first light emitting transistor includes a gate electrode connected to one of the first common clock line or the second common clock line, a source electrode connected to the emission start clock line, and a drain electrode connected to an emission set node, wherein the second light emitting transistor includes a gate electrode connected to the emission low voltage line, a source electrode connected to the emission set node, and a drain electrode connected to a gate electrode of the fifth light emitting transistor, wherein the third light emitting transistor includes a gate electrode connected to the gate electrode of the fifth light emitting transistor, a counter gate electrode connected to the gate electrode of the fifth light emitting transistor, a source electrode connected to an emission reset node, and a drain electrode connected to the emission low voltage line, wherein the fourth light emitting transistor includes a gate electrode connected to the emission set node, a source electrode connected to the emission high voltage line, and a drain electrode connected to the emission reset node, wherein the fifth light emitting transistor includes the gate electrode connected to the drain electrode of the second light emitting transistor, a source electrode connected to the emission control line, and a drain electrode connected to the emission low voltage line, wherein the sixth light emitting transistor includes a gate electrode connected to the emission reset node, a source electrode connected to the emission high voltage line, and a drain electrode connected to the emission control line, wherein the seventh light emitting transistor includes a gate electrode connected to the gate electrode of the fifth light emitting transistor, a source electrode connected to an emission carry line, and a drain electrode connected to the common low voltage line, wherein the eighth light emitting transistor includes a gate electrode connected to the emission reset node, a source electrode connected to the emission high voltage line, and a drain electrode connected to the emission carry line, wherein the first light emitting capacitor is connected between the gate electrode of the fifth light emitting transistor and the emission control line, and wherein the second light emitting capacitor is connected between the emission reset node and the emission high voltage line.

According to one or more embodiments, an electronic device including a display device configured to display an image, wherein the display device includes: a display panel including a display area and a non-display area; a first gate driver located in the non-display area adjacent to the display area; an emission controller located in the non-display area adjacent to an edge of the display panel; a second gate driver located in the non-display area between the first gate driver and the emission controller; and a plurality of pixel power lines connected to pixels of the display area, wherein at least one of the plurality of pixel power lines overlaps at least one of the second gate driver or the emission controller.

According to one or more embodiments, the plurality of pixel power lines includes a bias voltage line, a first initialization voltage line, a common voltage line, a second-first initialization voltage line, and a second-second initialization voltage line, wherein the second-first initialization voltage line overlaps the second gate driver, and wherein the second-second initialization voltage line overlaps the emission controller.

According to one or more embodiments, the electronic device includes a smartphone, a tablet, a laptop, a television, a desktop monitor, smart glasses, a smart watch, a head mounted display, or a vehicle.

According to one embodiment of the display device and the electronic device, the area of the bezel may be reduced.

For example, a second-first initialization voltage line required for driving a pixel may overlap a second gate driver, and a second-second initialization voltage line required for driving a pixel may overlap an emission controller. In other words, the second-first initialization voltage line and the second-second initialization voltage line may be located on the second gate driver and the emission controller without overlapping a first gate driver. Accordingly, the width of the first gate driver may be reduced. Therefore, the width of the first gate driver may be reduced by the region corresponding to the width of the second-first initialization voltage line and the width of the second-second initialization voltage line that have moved onto the second gate driver and the emission controller. In this way, a width of a scan driver may be reduced as the width of the first gate driver is reduced, so that a width of a non-display area (e.g., the width of the bezel or the width of the dead space) where the scan driver is located may be reduced. Accordingly, not only may the sense of immersion in the screen be increased, but the aesthetic sensibility of a display device 10 may also be improved.

The effects of the present disclosure are not limited to the above-described effects and other effects which are not described herein will become apparent to those skilled in the art from the following description.

### BRIEF DESCRIPTION OF THE DRAWINGS

The above and other aspects and features of the present disclosure will become more apparent by describing in detail embodiments thereof with reference to the attached drawings, in which:

FIG. 1 is a perspective view showing a display device according to one or more embodiments;

FIG. 2 is a plan view of the display panel of FIG. 1;

FIG. 3 is a cross-sectional view illustrating a display device according to one or more embodiments;

FIG. 4 is a circuit diagram of one pixel of a display device according to one or more embodiments;

FIG. 5 is an enlarged view of an area A1 of FIG. 2, according to one or more embodiments;

FIG. 6 is a circuit diagram of a first gate driver of a display device according to one or more embodiments;

FIG. 7 is a circuit diagram of a second gate driver of a display device according to one or more embodiments;

FIG. 8 is a circuit diagram of an emission controller of a display device according to one or more embodiments;

FIG. 9 is an enlarged view of an area A2 of FIG. 5, according to one or more embodiments;

FIG. 10 is an array diagram of the first gate driver according to one or more embodiments;

FIG. 11 is an array diagram in which power lines and clock lines are located in the first gate driver of FIG. 10, according to one or more embodiments;

FIG. 12 is an array diagram of the second gate driver according to one or more embodiments;

FIG. 13 is an array diagram in which power lines and clock lines are located in the second gate driver of FIG. 12, according to one or more embodiments;

FIG. 14 is an array diagram of the emission controller according to one or more embodiments;

FIG. 15 is an array diagram in which power lines and clock lines are located in the emission controller of FIG. 14, according to one or more embodiments;

FIG. 16 is an array diagram of a first scan driver according to one or more embodiments;

FIG. 17 is an enlarged view of the second gate driver and the emission controller of FIG. 16, according to one or more embodiments;

FIG. 18 is a block diagram of an electronic device according to one or more embodiments; and

FIGS. 19, 20, and 21, are schematic views illustrating electronic devices according to various embodiments.

### DETAILED DESCRIPTION

The present disclosure will now be described more fully hereinafter with reference to the accompanying drawings, in which embodiments of the present disclosure are shown. The present disclosure may, however, be embodied in different forms and should not be construed as limited to the embodiments set forth herein.

Rather, these embodiments are provided so that the present disclosure will be thorough and complete, and will fully convey the scope of the present disclosure to those skilled in the art.

It will also be understood that when a layer is referred to as being "on" another layer or substrate, it can be directly on the other layer or substrate, or intervening layers may also be present. The same reference numbers indicate the same components throughout the specification. In the attached figures, the thickness of layers and regions is exaggerated for clarity.

Although the terms "first", "second", etc. may be used herein to describe various elements, these elements, should not be limited by these terms. These terms may be used to distinguish one element from another element. Thus, a first element discussed below may be termed a second element without departing from teachings of the present disclosure. The description of an element as a "first" element may not require or imply the presence of a second element or other elements. The terms "first", "second", etc. may also be used herein to differentiate different categories or sets of elements. For conciseness, the terms "first", "second", etc. may represent "first-category (or first-set)", "second-category (or second-set)", etc., respectively.

It will also be understood that when a layer is referred to as being "on" another layer or substrate, it can be directly on the other layer or substrate, or intervening layers may also be present. In contrast, when an element is referred to as being "directly on" another element, there may be no intervening elements present.

Further, the phrase "in a plan view" means when an object portion is viewed from above, and the phrase "in a schematic cross-sectional view" means when a schematic cross-section taken by vertically cutting an object portion is viewed from the side. The terms "overlap" or "overlapped" mean that a first object may be above or below or to a side of a second object, and vice versa. Additionally, the term "overlap" may include layer, stack, face or facing, extending over, covering, or partly covering or any other suitable term as would be appreciated and understood by those of ordinary

skill in the art. The expression "not overlap" may include meaning such as "apart from" or "set aside from" or "offset from" and any other suitable equivalents as would be appreciated and understood by those of ordinary skill in the art. The terms "face" and "facing" may mean that a first object may directly or indirectly oppose a second object. In a case in which a third object intervenes between a first and second object, the first and second objects may be understood as being indirectly opposed to one another, although still facing each other.

The spatially relative terms "below," "beneath," "lower," "above," "upper," and/or the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned "below" or "beneath" another device may be placed "above" another device. Accordingly, the illustrative term "below" may include both the lower and upper positions. The device may also be oriented in other directions and thus the spatially relative terms may be interpreted differently depending on the orientations.

When an element is referred to as being "connected" or "coupled" to another element, the element may be "directly connected" or "directly coupled" to another element, or "electrically connected" or "electrically coupled" to another element with one or more intervening elements interposed therebetween. It will be further understood that when the terms "comprises," "comprising," "has," "have," "having," "includes" and/or "including" are used, they may specify the presence of stated features, integers, steps, operations, elements and/or components, but do not preclude the presence or addition of other features, integers, steps, operations, elements, components, and/or any combination thereof.

The terms "about" or "approximately" as used herein is inclusive of the stated value and means within an acceptable range of deviation for the particular value as determined by one of ordinary skill in the art, considering the measurement in question and the error associated with measurement of the particular quantity (for example, the limitations of the measurement system). For example, "about" may mean within one or more standard deviations, or within ± 30%, 20%, 10%, 5% of the stated value.

In the specification and the claims, the term "and/or" is intended to include any combination of the terms "and" and "or" for the purpose of its meaning and interpretation. For example, "A and/or B" may be understood to mean "A, B, or A and B." The terms "and" and "or" may be used in the conjunctive or disjunctive sense and may be understood to be equivalent to "and/or." In the specification and the claims, the phrase "at least one of" is intended to include the meaning of "at least one selected from the group of" for the purpose of its meaning and interpretation. For example, "at least one of A and B" may be understood to mean "A, B, or A and B."

Unless otherwise defined or implied, all terms used herein (including technical and scientific terms) have the same meaning as commonly understood by those skilled in the art to which this disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the specification.

Features of various embodiments of the present disclosure may be combined partially or totally. As will be clearly appreciated by those skilled in the art, technically various interactions and operations are possible. Various embodiments can be practiced individually or in combination.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, specific example embodiments will be described with reference to the accompanying drawings.

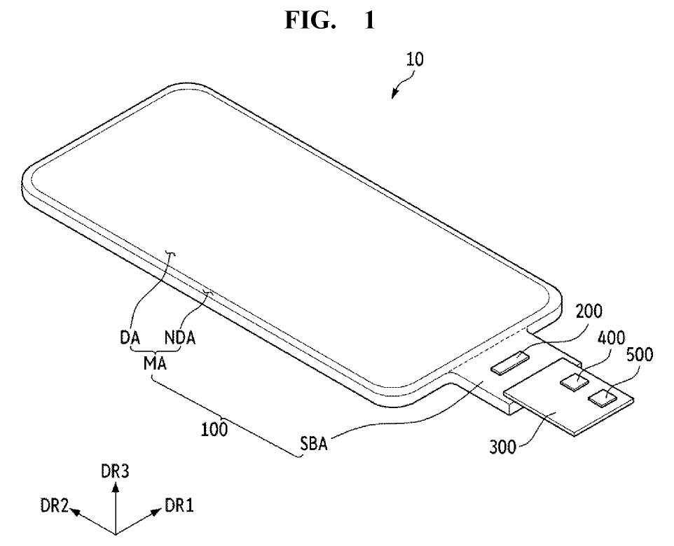

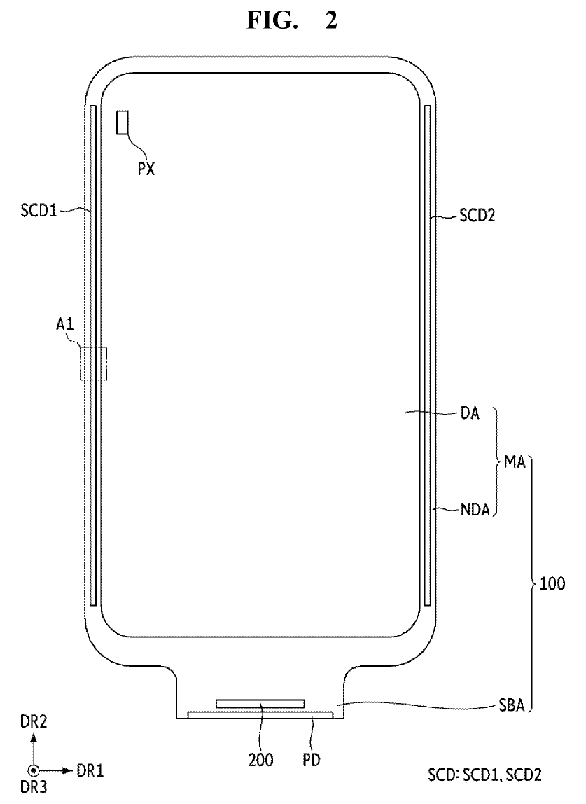

FIG. 1 is a perspective view showing a display device according to one or more embodiments, and FIG. 2 is a plan view of the display panel of FIG. 1.

Referring to FIGS. 1 and 2, the display device 10 may be applied to portable electronic devices such as a mobile phone, a smartphone, a tablet personal computer, a mobile communication terminal, an electronic organizer, an electronic book, a portable multimedia player (PMP), a navigation system, an ultra-mobile PC (UMPC), and/or the like. For example, the display device 10 may be applied as a display unit of a television, a laptop, a monitor, a billboard, or an Internet-of-Things (IoT) device. For another example, the display device 10 may be applied to wearable devices such as a smart watch, a watch phone, a glasses type display, or a head mounted display (HMD).

The display device 10 may have a planar shape similar to a quadrilateral shape. For example, the display device 10 may have a planar shape similar to a quadrilateral shape having a short side in a first direction DR1 and a long side in a second direction DR2. A corner where the short side in the first direction DR1 and the long side in the second direction DR2 meet may be right-angled or rounded with a selected curvature. The planar shape of the display device 10 is not limited to a quadrilateral shape, and may be formed in a shape similar to another polygonal shape, a circular shape, or elliptical shape.

The display device 10 may include a display panel 100, a display driver 200, a circuit board 300, a touch driver 400, and a power supply unit 500.

The display panel 100 may include a main region MA and a sub-region SBA.

The main region MA may include the display area DA in which pixels PX for displaying an image are arranged, and a non-display area NDA located around the display area DA along an edge or a periphery of the display area DA. The display area DA may emit light from a plurality of emission areas or a plurality of opening areas. For example, the display panel 100 may include a pixel circuit including switching elements, a pixel defining film defining an emission area or an opening area, and a self-light emitting element.

For example, the self-light emitting element may include at least one of an organic light emitting diode (OLED) including an organic light emitting layer, a quantum dot LED including a quantum dot light emitting layer, an inorganic LED including an inorganic semiconductor, or a micro LED, but is not limited thereto.

The non-display area NDA may be an area outside the display area DA. The non-display area NDA may be defined as an edge area of the main region MA of the display panel 100. In the non-display area NDA, a scan driver SCD that supplies gate signals and emission control signals to gate lines and emission control lines, and fan-out lines that connect the display driver 200 to the display area DA may be located. Here, the scan driver SCD may include a first scan driver SCD1 and a second scan driver SCD2 that are located in the non-display area NDA to face each other while the display area DA is interposed between the first scan driver SCD1 and the second scan driver SCD2.

The sub-region SBA may extend from one side of the main region MA. The sub-region SBA may include a flexible material which can be bent, folded, and/or rolled. For example, when the sub-region SBA is bent, the sub-region SBA may overlap the main region MA in a thickness direction (e.g., a third direction DR3). The sub-region SBA may include the display driver 200 and a pad portion connected to the circuit board 300. Optionally, the sub-region SBA may be omitted, and the display driver 200 and the pad portion may be located in the non-display area NDA.

The display driver 200 may output signals and voltages for driving the display panel 100. The display driver 200 may supply data voltages to data lines. The display driver 200 may supply a power voltage to the power line and may supply a gate control signal to the gate driver. The display driver 200 may be formed as an integrated circuit (IC) and mounted on the display panel 100 by a chip on glass (COG) method, a chip on plastic (COP) method, and/or an ultrasonic bonding method. For example, the display driver 200 may be located in the sub-region SBA, and may overlap the main region MA in the thickness direction (e.g., the third direction DR3) by bending of the sub-region SBA. For another example, the display driver 200 may be mounted on the circuit board 300.

The circuit board 300 may be attached to the pad portion of the display panel 100 by using an anisotropic conductive film (ACF). Lead lines of the circuit board 300 may be electrically connected to the pad portion of the display panel 100. The circuit board 300 may be a flexible printed circuit board (FPCB), a printed circuit board (PCB), or a flexible film such as a chip on film.

The touch driver 400 may be mounted on the circuit board 300. The touch driver 400 may be electrically connected to a touch sensing unit of the display panel 100. The touch driver 400 may supply a touch driving signal to a plurality of touch electrodes of the touch sensing unit and may sense an amount of change in capacitance between the plurality of touch electrodes. For example, the touch driving signal may be a pulse signal having a selected frequency. The touch driver 400 may calculate whether an input is made and input coordinates based on an amount of change in capacitance between the plurality of touch electrodes. The touch driver 400 may be formed as an integrated circuit (IC).

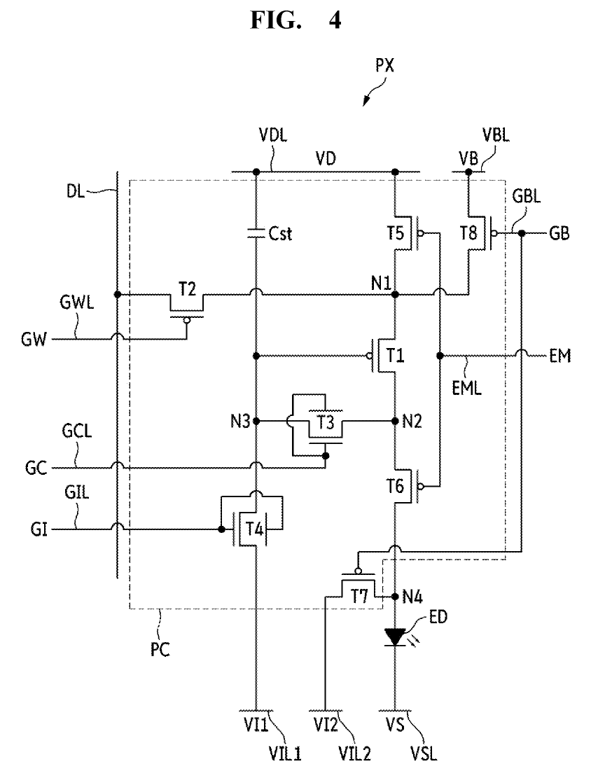

The power supply unit 500 may be located on the circuit board 300 to supply a power voltage to the display driver 200 and the display panel 100. The power supply unit 500 may generate a driving voltage to supply it to a driving voltage line VDL (e.g., see FIG. 4), generate an initialization voltage (e.g., a first initialization voltage and a second initialization voltage) to supply it to an initialization voltage line (e.g., a first initialization voltage line VIL1 and a second initialization voltage line VIL2 (e.g., see FIG. 4)), and generate a common voltage to supply it to a common electrode which is common to light emitting elements of the plurality of pixels. For example, the driving voltage may be a high potential voltage for driving the light emitting element, and the common voltage may be a low potential voltage for driving the light emitting element.

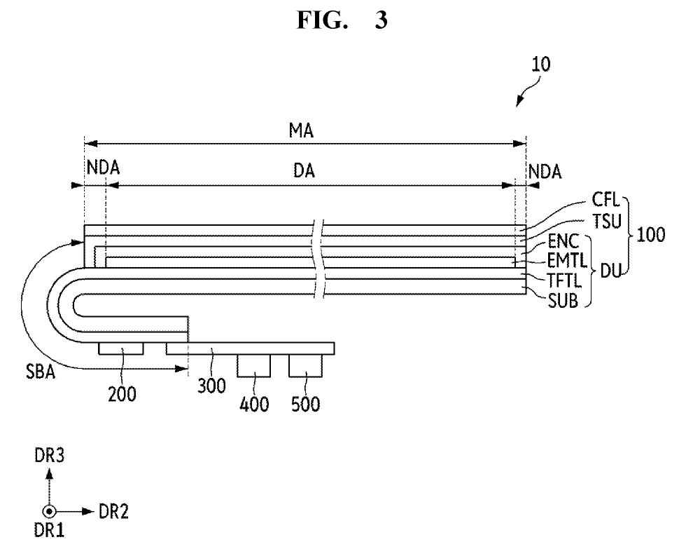

FIG. 3 is a cross-sectional view illustrating a display device according to one or more embodiments.

Referring to FIG. 3, the display panel 100 may include a display unit DU, a touch sensing unit TSU, and a color filter layer CFL. The display unit DU may include a substrate SUB, a thin film transistor layer TFTL, a light emitting element layer EMTL, and an encapsulation layer ENC.

The substrate SUB may be a base substrate or a base member. The substrate SUB may be a flexible substrate which can be bent, folded, and/or rolled. For example, the substrate SUB may include a polymer resin such as polyimide (PI), but is not limited thereto. For another example, the substrate SUB may include a glass material or a metal material.

The thin film transistor layer TFTL may be located on the substrate SUB. The thin film transistor layer TFTL may include a plurality of thin film transistors constituting a pixel circuit of pixels. The thin film transistor layer TFTL may further include gate lines, data lines, power lines, gate control lines, fan-out lines that connect the display driver 200 to the data lines, and lead lines that connect the display driver 200 to the pad portion. Each of the thin film transistors may include a semiconductor region, a source electrode, a drain electrode, and a gate electrode. For example, when the gate driver is formed on one side of the non-display area NDA of the display panel 100, the gate driver may include thin film transistors.

The thin film transistor layer TFTL may be located in the display area DA, the non-display area NDA, and the sub-region SBA. Thin film transistors, gate lines, data lines, and power lines of each of the pixels of the thin film transistor layer TFTL may be located in the display area DA. Gate control lines and fan-out lines of the thin film transistor layer TFTL may be located in the non-display area NDA. The lead lines of the thin film transistor layer TFTL may be located in the sub-region SBA.

The light emitting element layer EMTL may be located on the thin film transistor layer TFTL. The light emitting element layer EMTL may include a plurality of light emitting elements in which a pixel electrode, a light emitting layer, and a common electrode are sequentially stacked to emit light, and a pixel defining film defining pixels. The plurality of light emitting elements of the light emitting element layer EMTL may be located in the display area DA.

For example, the light emitting layer may be an organic light emitting layer including an organic material. The light emitting layer may include a hole transporting layer, an organic light emitting layer, and an electron transporting layer. When the pixel electrode receives a selected voltage through the thin film transistor of the thin film transistor layer TFTL and the common electrode receives the cathode voltage, holes and electrons may be transferred to the organic light emitting layer through the hole transporting layer and the electron transporting layer, respectively and may be combined with each other to emit light in the organic light emitting layer. For example, the pixel electrode may be an anode electrode, and the common electrode may be a cathode electrode, but the present disclosure is not limited thereto.

For another example, the plurality of light emitting elements may include a quantum dot light emitting diode including a quantum dot light emitting layer, an inorganic light emitting diode including an inorganic semiconductor, or a micro light emitting diode.

The encapsulation layer ENC may cover the top surface and the side surface of the light emitting element layer EMTL, and may protect the light emitting element layer EMTL. The encapsulation layer ENC may include at least one inorganic layer and at least one organic layer for encapsulating the light emitting element layer EMTL.

The touch sensing unit TSU may be located on the encapsulation layer ENC. The touch sensing unit TSU may include a plurality of touch electrodes for sensing a user's touch in a capacitive manner, and touch lines connecting the plurality of touch electrodes to the touch driver 400. For example, the touch sensing unit TSU may sense the user's touch by using a mutual capacitance method or a self-capacitance method.

For another example, the touch sensing unit TSU may be located on a separate substrate located on the display unit DU. In this case, the substrate supporting the touch sensing unit TSU may be a base member that encapsulates the display unit DU.

The plurality of touch electrodes of the touch sensing unit TSU may be located in a touch sensor area overlapping the display area DA. The touch lines of the touch sensing unit TSU may be located in a touch peripheral area that overlaps the non-display area NDA.

The color filter layer CFL may be located on the touch sensing unit TSU. The color filter layer CFL may include a plurality of color filters respectively corresponding to the plurality of emission areas. Each of the color filters may selectively transmit light of a specific wavelength and may block or absorb light of a different wavelength. The color filter layer CFL may absorb a part of light coming from the outside of the display device 10 to reduce reflected light due to external light. Accordingly, the color filter layer CFL may prevent color distortion caused by reflection of the external light.

Because the color filter layer CFL is directly located on the touch sensing unit TSU, the display device 10 may not require a separate substrate for the color filter layer CFL. Therefore, the thickness of the display device 10 may be relatively reduced.

The sub-region SBA of the display panel 100 may extend from one side of the main region MA. The sub-region SBA may include a flexible material that can be bent, folded, and/or rolled. For example, when the sub-region SBA is bent, the sub-region SBA may overlap the main region MA in the thickness direction (e.g., the third direction DR3). The sub-region SBA may include the display driver 200 and a pad portion PD (e.g., see FIG. 2) electrically connected to the circuit board 300.

As illustrated in FIG. 2, a first scan driver SCD1 and a second scan driver SCD2 for driving gate lines and emission control lines of the display panel 100 may be located in the non-display area NDA of the display panel 100.

FIG. 4 is a circuit diagram of one pixel PX of a display device according to one or more embodiments. For example, FIG. 4 may be a circuit diagram for the pixel PX of FIG. 2.

As illustrated in FIG. 4, the pixel PX may be connected to a write gate line GWL, a compensation gate line GCL, an initialization gate line GIL, a bias gate line GBL, an emission control line EML, a data line DL, a driving voltage line VDL, a common voltage line VSL, a first initialization voltage line VIL1, a second initialization voltage line VIL2, and a bias voltage line VBL.

The pixel PX may include a pixel circuit PC and a light emitting element ED. The pixel circuit PC and the light emitting element ED may be connected to a power line (e.g., a pixel power line), and the pixel power line may include the driving voltage line VDL, the common voltage line VSL, the first initialization voltage line VIL1, the second initialization voltage line VIL2, and the bias voltage line VBL described above.

The pixel circuit may be connected to the driving voltage line VDL, the first initialization voltage line VIL1, the second initialization voltage line VIL2, the bias voltage line VBL, the write data line GWL, the compensation gate line GCL, the initialization gate line GIL, the emission control signal line EML, the bias gate line GBL and the data line DL.

The light emitting element may be connected to the pixel circuit PC and the common voltage line VSL.

The pixel circuit PC may include a first transistor T1, a second transistor T2, a third transistor T3, a fourth transistor T4, a fifth transistor T5, a sixth transistor T6, a seventh transistor T7, an eighth transistor T8, and a capacitor Cst.

The first transistor T1 may include a gate electrode, a source electrode, and a drain electrode. The first transistor T1 may control a source-drain current (e.g., a driving current) according to the data voltage applied to the gate electrode. The driving current flowing through the channel region of the first transistor T1 may be proportional to the square of a difference between a threshold voltage and a voltage between the source electrode and the gate electrode of the first transistor T1.

The light emitting element ED may emit light by receiving a driving current. The light emission amount or the luminance of the light emitting element ED may be proportional to the magnitude of the driving current.

The light emitting element ED may be an organic light emitting diode (OLED) including a first electrode, a second electrode, and an organic light emitting layer located between the first electrode and the second electrode. For another example, the light emitting element ED may be an inorganic light emitting element including a first electrode, a second electrode, and an inorganic semiconductor located between the first electrode and the second electrode. For still another example, the light emitting element ED may be a quantum dot light emitting element including a first electrode, a second electrode, and a quantum dot light emitting layer located between the first electrode and the second electrode. For still another example, the light emitting element ED may be a micro light emitting diode.

The first electrode of the light emitting element ED may be electrically connected to a fourth node N4. The first electrode of the light emitting element ED may be connected to the drain electrode of the sixth transistor T6 and the source electrode of the seventh transistor T7 through the fourth node N4. The second electrode of the light emitting element ED may be connected to the common voltage line VSL. The second electrode of the light emitting element ED may receive a common voltage VS (e.g., low potential voltage) from the common voltage line VSL.

The second transistor T2 may be turned on by a write gate signal GW of the write gate line GWL to electrically connect the data line DL with a first node N1 that is the source electrode of the first transistor T1. The second transistor T2 may be turned on based on the write gate signal GW to supply the data voltage to the first node N1. The gate electrode of the second transistor T2 may be electrically connected to the write gate line GWL, the source electrode thereof may be electrically connected to the data line DL, and the drain electrode thereof may be electrically connected to the first node N1.

The third transistor T3 may be turned on by a compensation gate signal GC of the compensation gate line GCL to electrically connect a second node N2, which is the drain electrode of the first transistor T1, to a third node N3, which is the gate electrode of the first transistor T1. The third transistor T3 may be connected between the third node N3 and the second node N2. For example, the gate electrode of the third transistor T3 may be electrically connected to the compensation gate line GCL, the source electrode thereof may be electrically connected to the third node N3, and the drain electrode thereof may be electrically connected to the second node N2. The third transistor T3 may be turned on by a second gate signal of the compensation gate line GCL to electrically connect the second node N2, which is the drain electrode of the first transistor T1, to the third node N3, which is the gate electrode of the first transistor T1. The third transistor T3 may be a double gate transistor having two gate electrodes (e.g., a gate electrode and a counter gate electrode). The gate electrode and the counter gate electrode may be located to face each other in different layers.

The fourth transistor T4 may be turned on by an initialization gate signal GI of the initialization gate line GIL to electrically connect the third node N3, which is the gate electrode of the first transistor T1, to the first initialization voltage line VIL1. The fourth transistor T4 may be connected in series between the third node N3 and the first initialization voltage line VIL1. For example, the gate electrode of the fourth transistor T4 may be electrically connected to the initialization gate line GIL, the source electrode thereof may be electrically connected to the third node N3, and the drain electrode thereof may be electrically connected to the first initialization voltage line VIL1. The fourth transistor T4 may be a double gate transistor. The first initialization voltage line VIL1 may transmit a first initialization voltage VI1.

The fifth transistor T5 may be turned on by an emission control signal EM of the emission control line EML to electrically connect the driving voltage line VDL with the first node N1 that is the source electrode of the first transistor T1. The gate electrode of the fifth transistor T5 may be electrically connected to the emission control line EML, the source electrode thereof may be electrically connected to the driving voltage line VDL, and the drain electrode thereof may be electrically connected to the first node N1.

The sixth transistor T6 may be turned on by the emission control signal EM of the emission control line EML to electrically connect the second node N2 that is the drain electrode of the first transistor T1 with the fourth node N4 that is the first electrode of the light emitting element ED. The gate electrode of the sixth transistor T6 may be electrically connected to the emission control line EML, the source electrode thereof may be electrically connected to the second node N2, and the drain electrode thereof may be electrically connected to the fourth node N4.

When all of the fifth transistor T5, the first transistor T1, and the sixth transistor T6 are turned on, the driving current may be supplied to the light emitting element ED.

The seventh transistor T7 may be turned on by a bias gate signal GB of the bias gate line GBL to electrically connect the fourth node N4 that is the first electrode of the light emitting element ED with the second initialization voltage line VIL2. By turning on the seventh transistor T7 based on the fourth gate signal, the first electrode of the light emitting element ED may be discharged to a second initialization voltage V2. The gate electrode of the seventh transistor T7 may be electrically connected to the bias gate line GBL, the source electrode thereof may be electrically connected to the fourth node N4, and the drain electrode thereof may be electrically connected to the second initialization voltage line VIL2. The second initialization voltage line VIL2 may transmit a second initialization voltage VI2.

The eighth transistor T8 may be turned on by the bias gate signal GB of the bias gate line GBL to electrically connect the bias voltage line VBL with the first node N1 that is the source electrode of the first transistor T1. The eighth transistor T8 may be turned on according to the fourth gate signal GB to supply a bias voltage VB to the first node N1. The eighth transistor T8 may improve hysteresis of the first transistor T1 by supplying the bias voltage VB to the source electrode of the first transistor T1. The gate electrode of the eighth transistor T8 may be electrically connected to the bias gate line GBL, the source electrode thereof may be electrically connected to the bias voltage line VBL, and the drain electrode thereof may be electrically connected to the first node N1.

Each of the first transistor T1, the second transistor T2, the fifth transistor T5, the sixth transistor T6, the seventh transistor T7, and the eighth transistor T8 may include a silicon-based active layer. For example, each of the first transistor T1, the second transistor T2, the fifth transistor T5, the sixth transistor T6, the seventh transistor T7, and the eighth transistor T8 may be a p-type transistor including an active layer containing low temperature polycrystalline silicon (LTPS). The active layer containing low temperature polycrystalline silicon may have high electron mobility and excellent turn-on characteristics. Accordingly, in the display device 100, because the transistors having excellent turn-on characteristics are included, it is possible to stably and efficiently drive the plurality of pixels PX. Each of the first transistor T1, the second transistor T2, the fifth transistor T5, the sixth transistor T6, the seventh transistor T7, and the eighth transistor T8 may output a current flowing into the source electrode to the drain electrode based on a gate low voltage applied to the gate electrode.

The third transistor T3 and the fourth transistor T4 may be n-type transistors including an oxide-based active layer. The transistor including the oxide-based active layer may have a coplanar structure in which a gate electrode is located thereon. The transistor including the oxide-based active layer may output a current flowing into the drain electrode to the source electrode based on a gate high voltage applied to the gate electrode.

The capacitor Cst may be electrically connected between the third node N3 that is the gate electrode of the first transistor T1 and the driving voltage line VDL. For example, the first electrode of the capacitor Cst may be electrically connected to the third node N3, and the second electrode of the capacitor Cst may be electrically connected to the driving voltage line VDL, so that a potential difference between the driving voltage line VDL and the gate electrode of the first transistor T1 may be maintained.

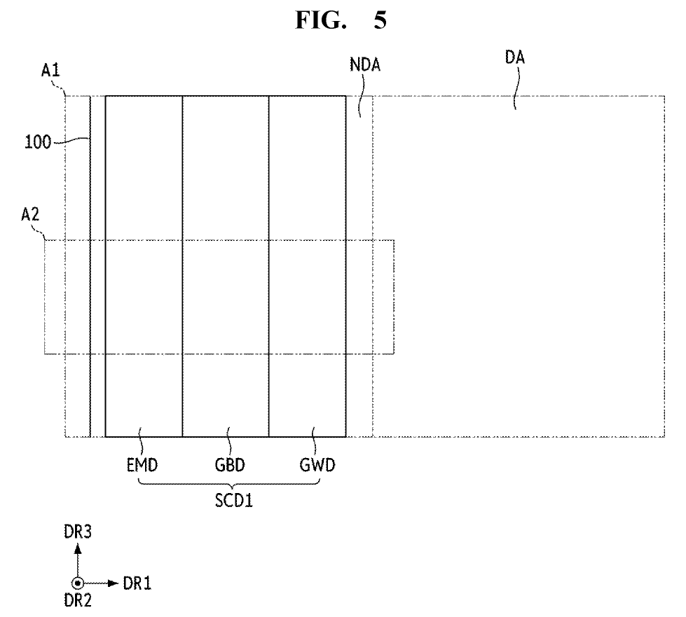

FIG. 5 is an enlarged view of an area A1 of FIG. 2.

As illustrated in FIG. 5, the first scan driver SCD1 may include a first gate driver GWD, a second gate driver GBD, and an emission controller EMD that are located between one edge of the display area DA and one edge of the display panel 100. The first gate driver GWD, the second gate driver GBD, and the emission controller EMD may be located in the non-display area DA. For example, the first gate driver GWD, the second gate driver GBD, and the emission controller EMD may be located along the reverse direction (hereinafter, referred to as a first reverse direction) of the first direction DR1 between one edge of the display area DA and one edge of the display panel 100.

The first gate driver GWD may be located adjacent to one edge of the display area DA and the second gate driver GBD. For example, the first gate driver GWD may be located between one edge of the display area DA and the second gate driver GBD. The first gate driver GWD may be, e.g., a write gate driver that generates a plurality of write gate signals and supplies the write gate signals to a plurality of write gate lines (e.g., a plurality of write gate lines GWL respectively connected to the plurality of pixels PX). The plurality of write gate signals from the first gate driver GWD may be sequentially supplied to the plurality of write gate lines GWL.

The second gate driver GBD may be located adjacent to the first gate driver GWD and the emission controller EMD. For example, the second gate driver GBD may be located between the first gate driver GWD and the emission controller EMD. The second gate driver GBD may be, e.g., a bias gate driver that generates a plurality of bias gate signals GB and supplies the bias gate signals to a plurality of bias gate lines GBL (e.g., a plurality of bias gate lines GBL respectively connected to the plurality of pixels PX). The plurality of bias gate signals GB from the second gate driver GBD may be sequentially supplied to the plurality of bias gate lines GBL.

The emission controller EMD may be located adjacent to the second gate driver GBD and one edge of the display panel 100. For example, the emission controller EMD may be located between the second gate driver GBD and one edge of the display panel 100. The emission controller EMD may generate, e.g., a plurality of emission control signals EM and supply the emission controls signals EM to a plurality of emission control lines EML (e.g., a plurality of emission control lines EML respectively connected to the plurality of pixels PX). The plurality of emission control signals EM from the emission controller EMD may be sequentially supplied to the plurality of emission control lines EML.

The second scan driver SCD2 may include a third gate driver, a fourth gate driver, and an emission controller (hereinafter, referred to as a second emission controller EMD) that are located between the other edge of the display area DA and the other edge of the display panel 100.

The third gate driver may be, e.g., a compensation gate driver that generates a plurality of compensation gate signals GC and supplies the compensation gate signals GC to a plurality of compensation gate lines GCL (e.g., a plurality of compensation gate lines GCL respectively connected to the plurality of pixels PX).

The fourth gate driver may be, e.g., an initialization gate driver that generates a plurality of initialization gate signals GI and supplies the initialization gate signals GI to a plurality of initialization gate lines GIL (e.g., a plurality of initialization gate lines GIL respectively connected to the plurality of pixels PX).

The second emission controller may generate a plurality of emission control signals EM and supply the emission control signals EM to a plurality of emission control lines EML (e.g., a plurality of emission control lines EML respectively connected to the plurality of pixels PX). For example, when the emission controller EMD of the first scan driver SCD1 described above is defined as the first emission controller EMD, the first emission controller EMD and the second emission controller may supply the plurality of emission control signals EM to the plurality of emission control lines EML together.

The configuration of the first scan driver SCD1 and the second scan driver SCD2 is not limited to the configuration described above. For example, the first scan driver SCD1 may include at least one of the first gate driver GWD, the second gate driver GBD, the third gate driver, or the fourth gate driver described above, and any one of the first emission controller EMD and the second emission controller described above. Further, the second scan driver may include at least one of the first gate driver GWD, the second gate driver GBD, the third gate driver, or the fourth gate driver described above, and any one of the first emission controller EMD and the second emission controller described above. In this case, the gate driver and the emission controller of the first scan driver SCD1 may be different from the gate driver and the emission controller of the second scan driver SCD2.

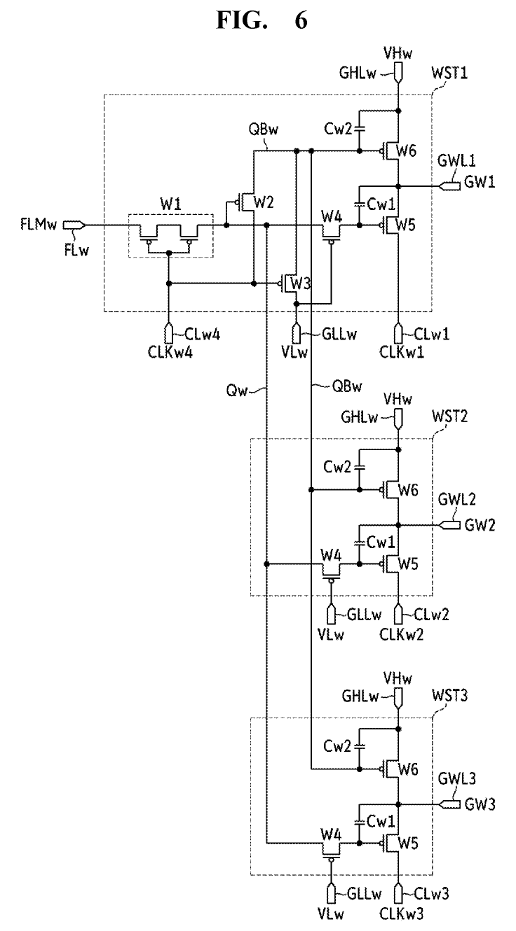

FIG. 6 is a circuit diagram of the first gate driver GWD of a display device according to one or more embodiments. For example, FIG. 6 may be a circuit diagram of the first gate driver GWD of FIG. 5.

The first gate driver GWD may include a plurality of write stages WST1, WST2, and WST3 that output a plurality of write gate signals GW1, GW2, and GW3, as illustrated in FIG. 6. For example, the first write stage WST1, the second write stage WST2, and the third write stage WST3 are illustrated in FIG. 6.

The first write stage WST1 may be connected to a first write gate line GWL1. The first write stage WST1 may output the first write gate signal GW1 to the first write gate line GWL1. For example, the first write stage WST1 may generate the first write gate signal GW1 based on a first write clock signal CLKw1, and provide the generated first write gate signal GW1 to the first write gate line GWL1.

The first write stage WST1 may include a first write transistor W1, a second write transistor W2, a third write transistor W3, a fourth write transistor W4, a fifth write transistor W5, a sixth write transistor W6, a first write capacitor Cw1, and a second write capacitor Cw2.

The gate electrode of the first write transistor W1 may be connected to a fourth write clock line CLw4, the source electrode thereof may be connected to a write start clock line FLw, and the drain electrode thereof may be connected to a write set node Qw. The first write transistor W1 may include a plurality of first write transistors W1 (e.g., two first write transistors W1 as illustrated in FIG. 6) connected in series between the write start clock line FLw and the write set node Qw. The fourth write clock line CLw4 may transmit a fourth write clock signal CLKw4, and the write start clock line FLw may transmit a write start clock signal FLMw.

The gate electrode of the second write transistor W2 may be connected to the write set node Qw, the source electrode thereof may be connected to a write reset node QBw, and the drain electrode thereof may be connected to the fourth write clock line CLw4. The fourth write clock line CLw4 may transmit the fourth write clock signal CLKw4.

The gate electrode of the third write transistor W3 may be connected to the fourth write clock line CLw4, the source electrode thereof may be connected to the write reset node QBw, and the drain electrode thereof may be connected to a write low voltage line GLLw. The write low voltage line GLLw may transmit a write low voltage VLw.

The gate electrode of the fourth write transistor W4 may be connected to the write low voltage line GLLw, the source electrode thereof may be connected to the write set node Qw, and the drain electrode thereof may be connected to the gate electrode of the fifth write transistor W5.

The gate electrode of the fifth write transistor W5 may be connected to the drain electrode of the fourth write transistor W4, the source electrode thereof may be connected to a first write clock line CLw1, and the drain electrode thereof may be connected to the first write gate line GWL1. The first write clock line CLw1 may transmit the first write clock signal CLKw1.

The gate electrode of the sixth write transistor W6 may be connected to the write reset node QBw, the source electrode thereof may be connected to a write high voltage line GHLw, and the drain electrode thereof may be connected to the first write gate line GWL1. The write high voltage line GHLw may transmit a write high voltage VHw.

The first write capacitor Cw1 may be connected between the gate electrode of the fifth write transistor W5 and the first write gate line GWL1.

The second write capacitor Cw2 may be connected between the write reset node QBw and the write high voltage line GHLw.

The second write stage WST2 may be connected to the write set node Qw and the write reset node QBw of the first write stage WST1. The second write stage WST2 may be connected to the second write gate line GWL2. The second write stage WST2 may output the second write gate signal GW2 to the second write gate line GWL2. For example, the second write stage WST2 may generate the second write gate signal GW2 based on a second write clock signal CLKw2, and provide the generated second write gate signal GW2 to the second write gate line GWL2.

The second write stage WST2 may include the fourth write transistor W4, the fifth write transistor W5, the sixth write transistor W6, the first write capacitor Cw1, and the second write capacitor Cw2.

The gate electrode of the fourth write transistor W4 provided in the second write stage WST2 may be connected to the write low voltage line GLLw, the source electrode thereof may be connected to the write set node Qw, and the drain electrode thereof may be connected to the gate electrode of the fifth write transistor W5 provided in the second write stage WST2.

The gate electrode of the fifth write transistor W5 provided in the second write stage WST2 may be connected to the drain electrode of the fourth write transistor W4 provided in the second write stage WST2, the source electrode thereof may be connected to a second write clock line CLw2, and the drain electrode thereof may be connected to the second write gate line GWL2. The second write clock line CLw2 may transmit the second write clock signal CLKw2.

The gate electrode of the sixth write transistor W6 provided in the second write stage WST2 may be connected to the write reset node QBw, the source electrode thereof may be connected to the write high voltage line GHLw, and the drain electrode thereof may be connected to the second write gate line GWL2.

The first write capacitor Cw1 provided in the second write stage WST2 may be connected between the second write gate line GWL2 and the gate electrode of the fifth write transistor W5 provided in the second write stage WST2.

The second write capacitor Cw2 provided in the second write stage WST2 may be connected between the write reset node QBw and the write high voltage line GHLw.

The third write stage WST3 may be connected to the write set node Qw and the write reset node QBw of the first write stage WST1. The third write stage WST3 may be connected to the third write gate line GWL3. The third write stage WST3 may output the third write gate signal GW3 to the third write gate line GWL3. For example, the third write stage WST3 may generate the third write gate signal GW3 based on a third write clock signal CLKw3, and provide the generated third write gate signal GW3 to the third write gate line GWL3.

The third write stage WST3 may include the fourth write transistor W4, the fifth write transistor W5, the sixth write transistor W6, the first write capacitor Cw1, and the second write capacitor Cw2.

The gate electrode of the fourth write transistor W4 provided in the third write stage WST3 may be connected to the write low voltage line GLLw, the source electrode thereof may be connected to the write set node Qw, and the drain electrode thereof may be connected to the gate electrode of the fifth write transistor W5 provided in the third write stage WST3.

The gate electrode of the fifth write transistor W5 provided in the third write stage WST3 may be connected to the drain electrode of the fourth write transistor W4 provided in the third write stage WST3, the source electrode thereof may be connected to a third write clock line CLw3, and the drain electrode thereof may be connected to the third write gate line GWL3. The third write clock line CLw3 may transmit the third write clock signal CLKw3. The first to fourth write clock signals CLKw1 to CLKw4 described above may be sequentially outputted with a phase difference. The first to fourth write clock signals CLKw1 to CLKw4 may be outputted multiple times during one frame period. The write start clock signal FLMw may be outputted once during one frame period and, in this case, the write start clock signal FLMw may be synchronized with any one of the pulses of the fourth write clock signal CLKw4.

The gate electrode of the sixth write transistor W6 provided in the third write stage WST3 may be connected to the write reset node QBw, the source electrode thereof may be connected to the write high voltage line GHLw, and the drain electrode thereof may be connected to the third write gate line GWL3.

The first write capacitor Cw1 provided in the third write stage WST3 may be connected between the third write gate line GWL3 and the gate electrode of the fifth write transistor W5 provided in the third write stage WST3.

The third write capacitor provided in the third write stage WST3 may be connected between the write reset node QBw and the write high voltage line GHLw.

In this way, the first gate driver GWD includes the first write stage WST1 and the plurality of write stages (e.g., the second write stage WST2 and the third write stage WST3) connected to the write set node Qw and the write reset node QBw of the first write stage WST1, so that the number of write transistors of the plurality of write stages (e.g., the second write stage WST2 and the third write stage WST3) may be reduced. In other words, because the write stages located at the rear end of the first write stage WST1 share the write set node Qw and the write reset node QBw of the first write stage WST1, the write stages (e.g., the second write stage WST2 and the third write stage WST3) may be formed to have a size smaller than the size of the first write stage WST1.

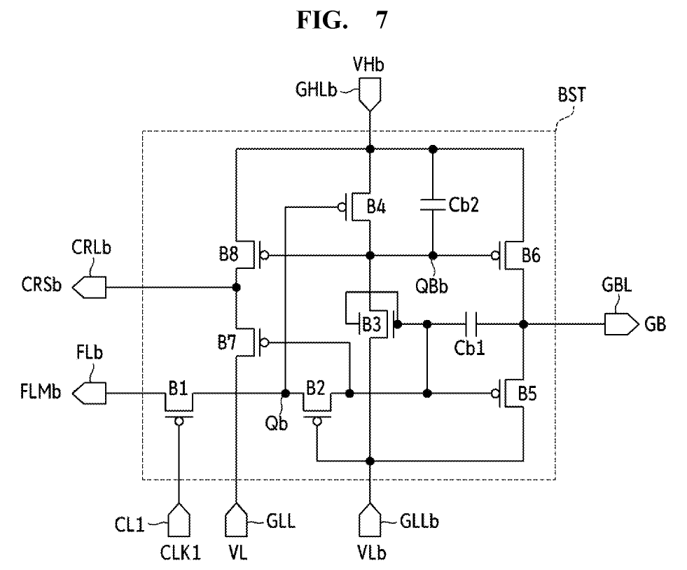

FIG. 7 is a circuit diagram of the second gate driver GBD of a display device according to one or more embodiments. For example, FIG. 7 may be a circuit diagram of the second gate driver GBD of FIG. 5.

The second gate driver GBD may include a plurality of bias stages BST that output the plurality of bias gate signals GB. Because the configurations of the plurality of bias stages BST are substantially the same, one bias stage BST (e.g., a first bias stage) illustrated in FIG. 7 will be representatively described.

The bias stage BST (e.g., the first bias stage) may be connected to the bias gate line GBL (e.g., a first bias gate line GBL). The bias stage BST may output the bias gate signal GB (e.g., a first bias gate signal) to the bias gate line GBL. For example, the bias stage BST may generate the bias gate signal GB based on the first common clock signal CLK1, and provide the generated bias gate signal GB to the bias gate line GBL.

The bias stage BST (e.g., the first bias stage) may be connected to a bias carry line CRLb (e.g., a first bias carry line). The bias stage BST may output a bias carry signal CRSb (e.g., a first bias carry signal) to the bias carry line CRLb. For example, the bias stage BST may generate the bias carry signal CRSb based on the first common clock signal CLK1, and provide the generated bias carry signal CRSb to the bias carry line CRLb.

The bias stages BST adjacent to each other may be connected to each other by the bias carry line CRLb. Accordingly, the rear bias stage BST may operate by the bias carry signal CRSb received from the front bias stage BST.

The bias stage BST may include a first bias transistor B1, a second bias transistor B2, a third bias transistor B3, a fourth bias transistor B4, a fifth bias transistor B5, a sixth bias transistor B6, a seventh bias transistor B7, an eighth bias transistor B8, a first bias capacitor Cb1, and a second bias capacitor Cb2.

The gate electrode of the first bias transistor B1 may be connected to the first common clock line CL1, the source electrode thereof may be connected to a bias start clock line FLb, and the drain electrode thereof may be connected to a bias set node Qb. The first common clock line CL1 may transmit the first common clock signal CLK1, and the bias start clock line FLb may transmit a bias start clock signal FLMb.

The gate electrode of the second bias transistor B2 may be connected to a bias low voltage line GLLb, the source electrode thereof may be connected to the bias set node Qb, and the drain electrode thereof may be connected to the gate electrode of the fifth bias transistor B5. The bias low voltage line GLLb may transmit a bias low voltage VLb.

The gate electrode of the third bias transistor B3 may be connected to the gate electrode of the fifth bias transistor B5, the counter gate electrode thereof may be connected to the gate electrode of the fifth bias transistor B5, the source electrode thereof may be connected to a bias reset node QBb, and the drain electrode thereof may be connected to the bias low voltage line GLLb.

The gate electrode of the fourth bias transistor B4 may be connected to the bias set node Qb, the source electrode thereof may be connected to a bias high voltage line GHLb, and the drain electrode thereof may be connected to the bias reset node QBb. The bias high voltage line GHLb may transmit a bias high voltage VHb.

The gate electrode of the fifth bias transistor B5 may be connected to the drain electrode of the second bias transistor B2, the source electrode thereof may be connected to the bias gate line GBL, and the drain electrode thereof may be connected to the bias low voltage line GLLb.

The gate electrode of the sixth bias transistor B6 may be connected to the bias reset node QBb, the source electrode thereof may be connected to the bias high voltage line GHLb, and the drain electrode thereof may be connected to the bias gate line GBL.

The gate electrode of the seventh bias transistor B7 may be connected to the gate electrode of the fifth bias transistor B5, the source electrode thereof may be connected to the bias carry line CRLb, and the drain electrode thereof may be connected to a common low voltage line GLL. The common low voltage line GLL may transmit a common low voltage VL.

The gate electrode of the eighth bias transistor B8 may be connected to the bias reset node QBb, the source electrode thereof may be connected to the bias high voltage line GHLb, and the drain electrode thereof may be connected to the bias carry line CRLb.

The first bias capacitor Cb1 may be connected between the bias gate line GBL and the gate electrode of the fifth bias transistor B5.

The second bias capacitor Cb2 may be connected between the bias reset node QBb and the bias high voltage line GHLb.

A second common clock signal CLK2 and the bias carry signal CRSb from the bias stage BST described above may be applied to the first bias transistor B1 of another bias stage BST (e.g., a rear bias stage) located at the rear end of the bias stage BST. For example, a second common clock line may be connected to the gate electrode of the first bias transistor included in the rear stage, so that the second common clock signal from the second common clock line may be supplied to the first bias transistor of the rear stage. Further, the bias carry line CRLb may be connected to the source electrode of the first bias transistor included in the rear stage, so that the bias carry signal CRSb from the bias carry line CRLb may be supplied to the first bias transistor B1 of the rear stage.

The first common clock signal CLK1 and the second common clock signal CLK2 described above may be sequentially outputted with a phase difference. The first common clock signal CLK1 and the second common clock signal CLK2 may be outputted multiple times during one frame period. The bias start clock signal FLMb may be outputted once during one frame period and, in this case, the bias start clock signal FLMb may be synchronized with any one of the pulses of the first common clock signal CLK1.

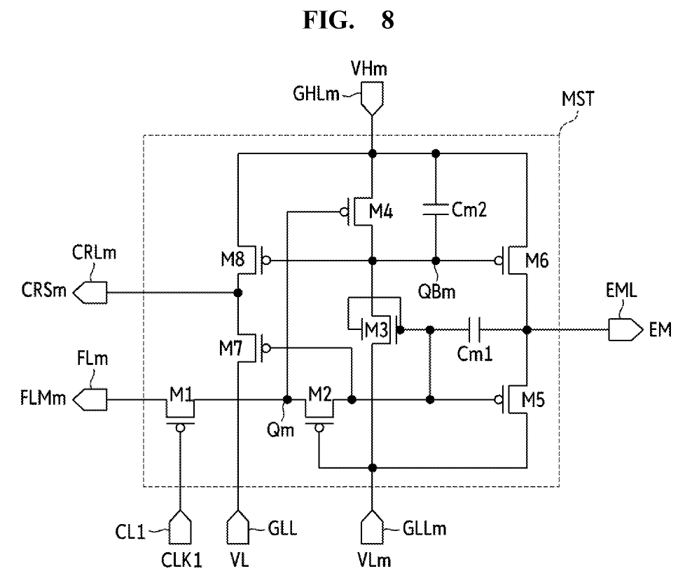

FIG. 8 is a circuit diagram of the emission controller EMD of a display device according to one or more embodiments. For example, FIG. 8 may be a circuit diagram of the emission controller EMD of FIG. 5.

The emission controller EMD may include a plurality of emission stages MST that output the plurality of emission control signals EM. Because the configurations of the plurality of emission stages MST are substantially the same, one emission stage MST (e.g., a first emission stage) illustrated in FIG. 7 will be representatively described.

The emission stage MST (e.g., the first emission stage) may be connected to the emission control line EML (e.g., a first emission control line). The emission stage MST may output the emission control signal EM (e.g., a first emission control signal) to the emission control line EML. For example, the emission stage MST may generate the emission control signal EM based on the first common clock signal CLK1, and provide the generated emission control signal EM to the emission control line EML.

The emission stage MST (e.g., the first emission stage) may be connected to an emission carry line CRLm (e.g., a first emission carry line). The emission stage MST may output an emission carry signal CRSm (e.g., a first emission carry signal) to the emission carry line CRLm. For example, the emission stage MST may generate the emission carry signal CRSm based on the first common clock signal CLK1, and provide the generated emission carry signal CRSm to the emission carry line CRLm.

The emission stages MST adjacent to each other may be connected to each other by the emission carry line CRLm. Accordingly, the rear emission stage MST may operate by the emission carry signal CRSm received from the front emission stage MST.

The emission stage MST may include a first light emitting transistor M1, a second light emitting transistor M2, a third light emitting transistor M3, a fourth light emitting transistor M4, a fifth light emitting transistor M5, a sixth light emitting transistor M6, a seventh light emitting transistor M7, an eighth light emitting transistor M8, a first light emitting capacitor Cm1, and a second light emitting capacitor Cm2.

The gate electrode of the first light emitting transistor M1 may be connected to the first common clock line CL1, the source electrode thereof may be connected to an emission start clock line FLm, and the drain electrode thereof may be connected to an emission set node Qm.

The gate electrode of the second light emitting transistor M2 may be connected to an emission low voltage line GLLm, the source electrode thereof may be connected to the emission set node Qm, and the drain electrode thereof may be connected to the gate electrode of the fifth light emitting transistor M5. The emission low voltage line GLLm may transmit the emission low voltage VLm.

The gate electrode of the third light emitting transistor M3 may be connected to the gate electrode of the fifth light emitting transistor M5, the counter gate electrode thereof may be connected to the gate electrode of the fifth light emitting transistor M5, the source electrode thereof may be connected to an emission reset node QBm, and the drain electrode thereof may be connected to the emission low voltage line GLLm.

The gate electrode of the fourth light emitting transistor M4 may be connected to the emission set node Qm, the source electrode thereof may be connected to an emission high voltage line GHLm, and the drain electrode thereof may be connected to the emission reset node QBm. The emission high voltage line GHLm may transmit an emission high voltage VHm.

The gate electrode of the fifth light emitting transistor M5 may be connected to the drain electrode of the second light emitting transistor M2, the source electrode thereof may be connected to the emission control line EML, and the drain electrode thereof may be connected to the emission low voltage line GLLm.

The gate electrode of the sixth light emitting transistor M6 may be connected to the emission reset node QBm, the source electrode thereof may be connected to the emission high voltage line GHLm, and the drain electrode thereof may be connected to the emission control line EML.

The gate electrode of the seventh light emitting transistor M7 may be connected to the gate electrode of the fifth light emitting transistor M5, the source electrode thereof may be connected to the emission carry line CRLm, and the drain electrode thereof may be connected to the common low voltage line GLL.

The gate electrode of the eighth light emitting transistor M8 may be connected to the emission reset node QBm, the source electrode thereof may be connected to the emission high voltage line GHLm, and the drain electrode thereof may be connected to the emission carry line CRLm.

The first light emitting capacitor Cm1 may be connected between the emission control line EML and the gate electrode of the fifth light emitting transistor M5.

The second light emitting capacitor Cm2 may be connected between the emission reset node QBm and the emission high voltage line GHLm.

The second common clock signal CLK2 and the emission carry signal CRSm from the emission stage MST described above may be applied to the first light emitting transistor M1 of another emission stage (e.g., a rear emission stage) located at the rear end of the emission stage MST. For example, the second common clock line may be connected to the gate electrode of the first light emitting transistor included in the rear emission stage, so that the second common clock signal from the second common clock line may be supplied to the first light emitting transistor of the rear emission stage. Further, the emission carry line CRLm may be connected to the source electrode of the first light emitting transistor included in the rear emission stage, so that the emission carry signal CRSm from the emission carry line CRLm may be supplied to the first light emitting transistor of the rear emission stage.

The first common clock signal CLK1, the second common clock signal CLK2, and the common low voltage VL described above may be supplied together to the second gate driver GBD and the emission controller EMD.

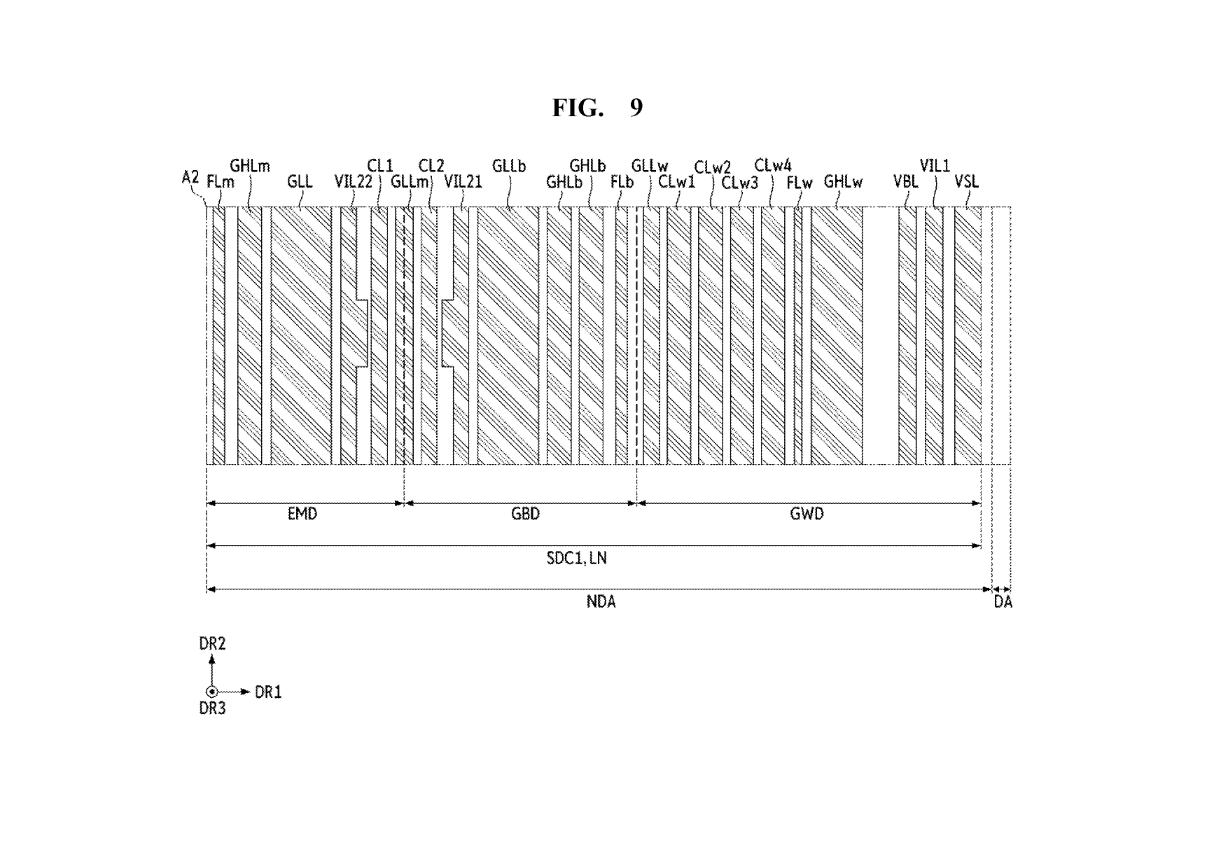

FIG. 9 is an enlarged view of an area A2 of FIG. 5, according to one or more embodiments. For example, FIG. 9 is a diagram illustrating the arrangement relationship of clock lines and power lines connected to the first scan driver SCD1 of a display device according to one or more embodiments.

The first gate driver GWD may be connected to a plurality of power lines (e.g., the power lines GHLw and GLLw) and a plurality of clock lines FLw, CLw1, CLw2, CLw3, and CLw4. For example, the first gate driver GWD may be connected to the write high voltage line GHLw, the write low voltage line GLLw, the write start clock line FLw, the first write clock line CLw1, the second write clock line CLw2, the third write clock line CLw3, and the fourth write clock line CLw4. The write high voltage line GHLw, the write low voltage line GLLw, the write start clock line FLw, the first write clock line CLw1, the second write clock line CLw2, the third write clock line CLw3, and the fourth write clock line CLw4 may overlap the first gate driver GWD.

The second gate driver GBD may be connected to a plurality of power lines (e.g., the power lines GHLb, GLLb, and GLL) and a plurality of clock lines FLb, CL1, and CL2. For example, the second gate driver GBD may be connected to the bias high voltage line GHLb, the bias low voltage line GLLb, the common low voltage line GLL, the bias start clock line FLb, the first common clock line CL1, and the second common clock line CL2. The bias high voltage line GHLb, the bias low voltage line GLLb, the bias start clock line FLb, and the second common clock line CL2 may overlap the second gate driver GBD.

The emission controller EMD may be connected to a plurality of power lines (e.g., the power lines GHLm, GLLm, and GLL) and a plurality of clock lines FLm, CL1, and CL2. For example, the emission controller EMD may be connected to the emission high voltage line GHLm, the emission low voltage line GLLm, the common low voltage line GLL, the emission start clock line FLm, the first common clock line CL1, and the second common clock line CL2. The emission high voltage line GHLm, the emission low voltage line GLLm, the common low voltage line GLL, the emission start clock line FLm, and the first common clock line CL1 may overlap the emission controller EMD. Here, the emission low voltage line GLLm may further overlap the second gate driver GBD described above.

Further, some of the power lines (e.g., the power lines VBL, VIL1, VSL, VIL21, and VIL22) connected to the pixel PX may overlap the first gate driver GWD, some others of the power lines (e.g., the power lines VBL, VIL1, VSL, VIL21, and VIL22) connected to the pixel PX may overlap the second gate driver GBD, and yet some others of the power lines (e.g., the power lines VBL, VIL1, VSL, VIL21, and VIL22) connected to the pixel PX may overlap the emission controller EMD. For example, the bias voltage line VBL, the first initialization voltage line VIL1, and the common voltage line VSL may be located on the first gate driver GWD to overlap the first gate driver GWD. Further, the second initialization voltage line VIL2 may include a second-first initialization voltage line VIL21 and a second-second initialization voltage line VIL22, so that the second-first initialization voltage line VIL21 may be located on the second gate driver GBD to overlap the second gate driver GBD, and the second-second initialization voltage line VIL22 may be located on the emission controller EMD to overlap the emission controller EMD.

The power lines and the clock lines described above may be sequentially located along the first direction DR1. For example, along the first direction DR1, the emission start clock line FLm, the emission high voltage line GHLm, the common low voltage line GLL, the second-second initialization voltage line VIL22, the first common clock line CL1, the emission low voltage line GLLm, the second common clock line CL2, the second-first initialization voltage line VIL21, the bias low voltage line GLLb, two bias high voltage lines GHLb, the bias start clock line FLb, the write low voltage line GLLw, the first write clock line CLw1, the second write clock line CLw2, the third write clock line CLw3, the fourth write clock line CLw4, the write start clock line FLw, the write high voltage line GHLw, the bias voltage line VBL, the first initialization voltage line VIL1, and the common voltage line VSL may be located in the non-display area DA.

In a plan view, the second-first initialization voltage line VIL21 may be located between the second common clock line CL2 and the bias low voltage line GLLb.

In a plan view, the second-second initialization voltage line VIL22 may be located between the first common clock line CL1 and the common low voltage line GLL.

The pixels PX may include a first pixel providing first light, a second pixel providing second light, and a third pixel providing third light, so that the first pixel providing the first light and the second pixel providing the second light may each be connected to the second-first initialization voltage line VIL21, and the third pixel providing the third light may be connected to the second-second initialization voltage line VIL22. For example, the drain electrode of the seventh transistor T7 (e.g., see FIG. 4) of the first pixel providing the first light may be connected to the second-first initialization voltage line VIL21, the drain electrode of the seventh transistor T7 (e.g., see FIG. 4) of the second pixel providing the second light may be connected to the second-first initialization voltage line VIL21, and the drain electrode of the seventh transistor T7 (e.g., see FIG. 4) of the third pixel providing the third light may be connected to the second-second initialization voltage line VIL22. Here, the first light, the second light, and the third light may be lights of different wavelength bands. For example, the first light may be light of a red wavelength band, the second light may be light of a blue wavelength band, and the third light may be light of a green wavelength band.

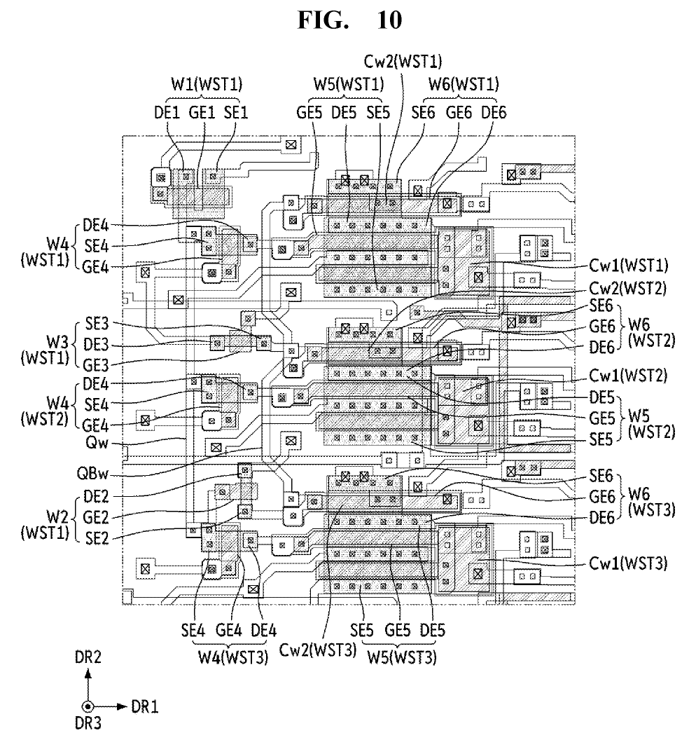

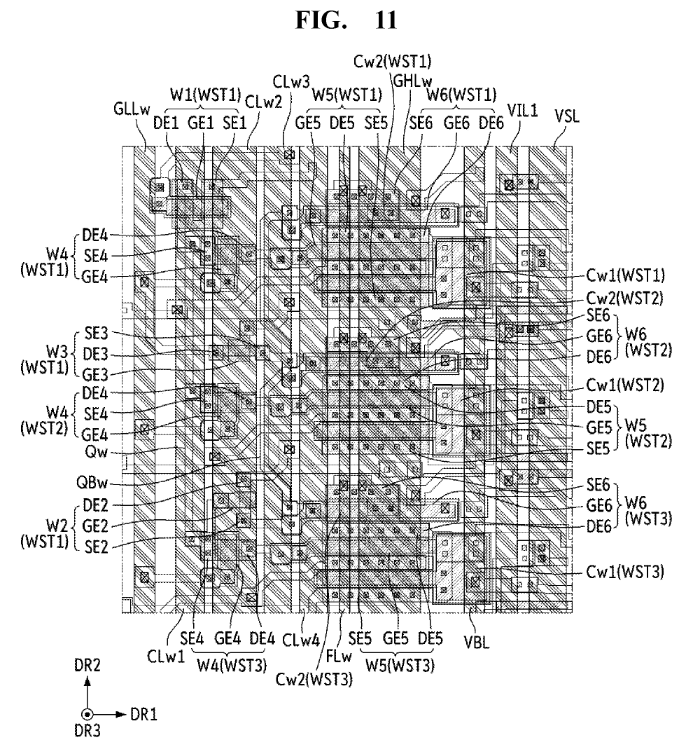

FIG. 10 is an array diagram of the first gate driver GWD according to one or more embodiments. For example, FIG. 10 may be an array diagram of the first gate driver GWD illustrated in FIG. 6 described above. Further, FIG. 11 is an array diagram in which power lines and clock lines are located in the first gate driver GWD of FIG. 10.

The first write transistor W1 of the first write stage WST1 may include a gate electrode GE1 connected to the fourth write clock line CLw4, a source electrode SE1 connected to the write start clock line FLw, and a drain electrode DE1 connected to the write set node Qw.

The second write transistor W2 of the first write stage WST1 may include a gate electrode GE2 connected to the write set node Qw, a source electrode SE2 connected to the write reset node QBw, and a drain electrode DE2 connected to the fourth write clock line CLw4.

The third write transistor W3 of the first write stage WST1 may include a gate electrode GE3 connected to the fourth write clock line CLw4, a source electrode SE3 connected to the write reset node QBw, and a drain electrode DE3 connected to the write low voltage line GLLw.

The fourth write transistor W4 of the first write stage WST1 may include a gate electrode GE4 connected to the write low voltage line GLLw, a source electrode SE4 connected to the write set node Qw, and a drain electrode DE4 connected to a gate electrode GE5 of the fifth write transistor W5.

The fifth write transistor W5 of the first write stage WST1 may include a gate electrode GE5 connected to the drain electrode DE4 of the fourth write transistor W4, a source electrode SE5 connected to the first write clock line CLw1, and a drain electrode DE5 connected to the first write gate line GWL1.

The sixth write transistor W6 of the first write stage WST1 may include a gate electrode GE6 connected to the write reset node QBw, a source electrode SE6 connected to the write high voltage line GHLw, and a drain electrode DE6 connected to the first write gate line GWL1.

The first write capacitor Cw1 of the first write stage WST1 may be connected between the first write gate line GWL1 and the gate electrode GE5 of the fifth write transistor W5.

The second write capacitor Cw2 of the first write stage WST1 may be connected between the write reset node QBw and the write high voltage line GHLw.

The fourth write transistor W4 of the second write stage WST2 may include the gate electrode GE4 connected to the write low voltage line GLLw, the source electrode SE4 connected to the write set node Qw, and the drain electrode DE4 connected to the gate electrode GE5 of the fifth write transistor W5.

The fifth write transistor W5 of the second write stage WST2 may include the gate electrode GE5 connected to the drain electrode DE4 of the fourth write transistor W4, the source electrode SE5 connected to the second write clock line CLw2, and the drain electrode DE5 connected to the second write gate line GWL2.

The sixth write transistor W6 of the second write stage WST2 may include the gate electrode GE6 connected to the write reset node QBw, the source electrode SE6 connected to the write high voltage line GHLw, and the drain electrode DE6 connected to the second write gate line GWL2.

The first write capacitor Cw1 of the second write stage WST2 may be connected between the second write gate line GWL2 and the gate electrode GE5 of the fifth write transistor W5.

The second write capacitor Cw2 of the second write stage WST2 may be connected between the write reset node QBw and the write high voltage line GHLw.

The fourth write transistor W4 of the third write stage WST3 may include the gate electrode GE4 connected to the write low voltage line GLLw, the source electrode SE4 connected to the write set node Qw, and the drain electrode DE4 connected to the gate electrode GE5 of the fifth write transistor W5.

The fifth write transistor W5 of the third write stage WST3 may include the gate electrode GE5 connected to the drain electrode DE4 of the fourth write transistor W4, the source electrode SE5 connected to the third write clock line CLw3, and the drain electrode DE5 connected to the third write gate line GWL3.

The sixth write transistor W6 of the third write stage WST3 may include the gate electrode GE6 connected to the write reset node QBw, the source electrode SE6 connected to the write high voltage line GHLw, and the drain electrode DE6 connected to the third write gate line GWL3.

The first write capacitor Cw1 of the third write stage WST3 may be connected between the third write gate line GWL3 and the gate electrode GE5 of the fifth write transistor W5.

The second write capacitor Cw2 of the third write stage WST3 may be connected between the write reset node QBw and the write high voltage line GHLw.

The write high voltage line GHLw, the write low voltage line GLLw, the write start clock line FLw, the first write clock line CLw1, the second write clock line CLw2, the third write clock line CLw3, and the fourth write clock line CLw4 may overlap the first gate driver GWD. For example, the write high voltage line GHLw may overlap the fifth write transistor W5 and the sixth write transistor W6, the second write clock line CLw2 may overlap the second write transistor W2, the third write transistor W3, and the fourth write transistor W4, and the first write clock line CLw1 may overlap the first write transistor W1.

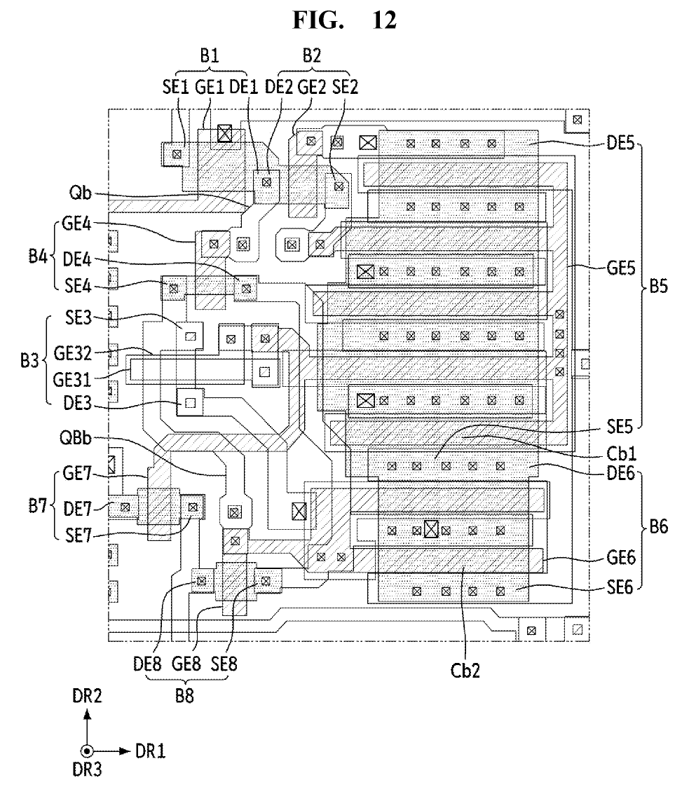

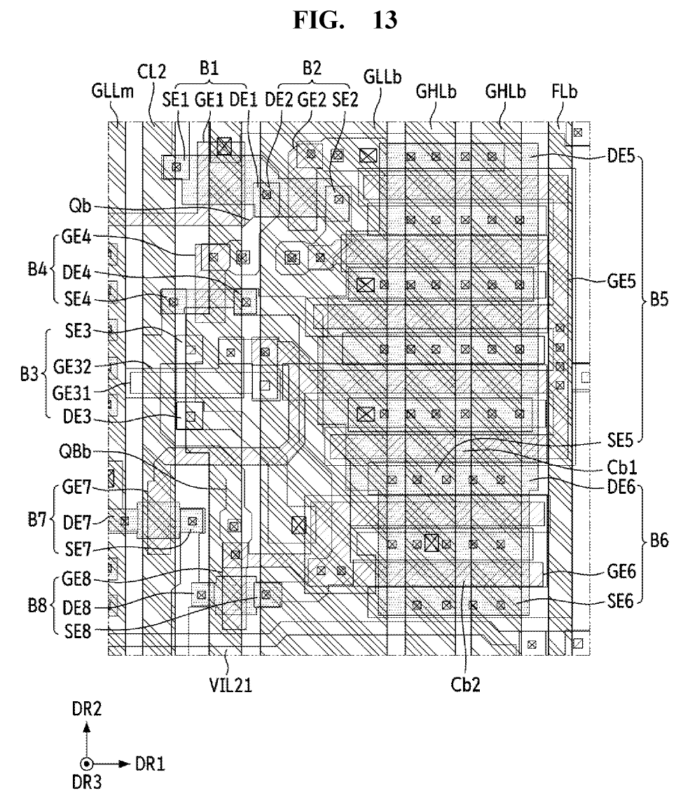

FIG. 12 is an array diagram of the second gate driver GBD according to one or more embodiments. For example, FIG. 12 may be an array diagram of the second gate driver GBD illustrated in FIG. 5 and FIG. 7) described above. Further, FIG. 13 is an array diagram in which power lines and clock lines are located in the second gate driver GBD of FIG. 12.

The first bias transistor B1 may include a gate electrode GE1 connected to the first common clock line CL1, a source electrode SE1 connected to the bias start clock line FLb, and a drain electrode DE1 connected to the bias set node Qb.

The second bias transistor B2 may include a gate electrode GE2 connected to the bias low voltage line GLLb, a source electrode SE2 connected to the bias set node Qb, and a drain electrode DE2 connected to the gate electrode GE5 of the fifth bias transistor B5.

The third bias transistor B3 may include a gate electrode GE31 connected to the gate electrode GE5 of the fifth bias transistor B5, a counter gate electrode GE32 connected to the gate electrode GE5 of the fifth bias transistor B5, a source electrode SE3 connected to the bias reset node QBb, and a drain electrode DE3 connected to the bias low voltage line GLLb.

The fourth bias transistor B4 may include a gate electrode GE4 connected to the bias set node Qb, a source electrode SE4 connected to the bias high voltage line GHLb, and a drain electrode DE4 connected to the bias reset node QBb.

The fifth bias transistor B5 may include a gate electrode GE5 connected to the drain electrode DE2 of the second bias transistor B2, a source electrode SE5 connected to the bias gate line GBL, and a drain electrode DE5 connected to the bias low voltage line GLLb.

The sixth bias transistor B6 may include a gate electrode GE6 connected to the bias reset node QBb, a source electrode SE6 connected to the bias high voltage line GHLb, and a drain electrode DE6 connected to the bias gate line GBL.

The seventh bias transistor B7 may include a gate electrode GE7 connected to the gate electrode GE5 of the fifth bias transistor B5, a source electrode SE7 connected to the bias carry line CRLb, and a drain electrode DE7 connected to the common low voltage line GLL.

The eighth bias transistor B8 may include a gate electrode GE8 connected to a bias reset node QBb, a source electrode SE8 connected to the bias high voltage line GHLb, and a drain electrode DE8 connected to the bias carry line CRLb.

The first bias capacitor Cb1 may be connected between the bias gate line GBL and the gate electrode GE5 of the fifth bias transistor B5.

The second bias capacitor Cb2 may be connected between the bias reset node QBb and the bias high voltage line GHLb.

The second gate driver GBD may be connected to the bias high voltage line GHLb, the bias low voltage line GLLb, the common low voltage line GLL, the bias start clock line FLb, the first common clock line CL1, and the second common clock line CL2. The bias high voltage line GHLb, the bias low voltage line GLLb, the bias start clock line FLb, and the second common clock line CL2 may overlap the second gate driver GBD. For example, two bias high voltage lines GHLb may overlap the fifth bias transistor B5 and the sixth bias transistor B6, the bias low voltage line GLLb may overlap the second bias transistor B2, the second-first initialization voltage line VIL21 may overlap the first bias transistor B1, the third bias transistor B3, the fourth bias transistor B4, and the eighth bias transistor B8, and the second common clock line CL2 may overlap the seventh bias transistor B7.

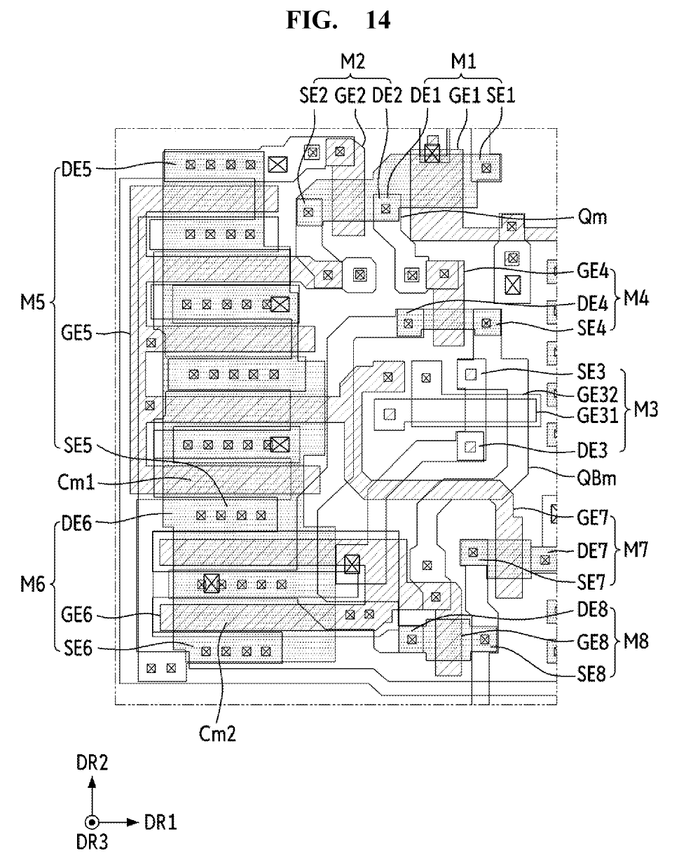

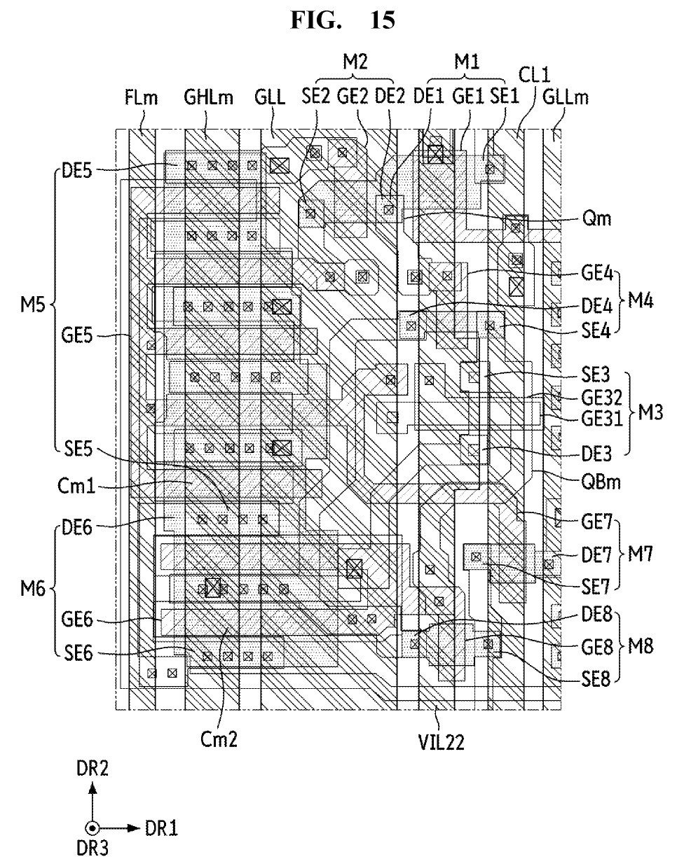

FIG. 14 is an array diagram of the emission controller EMD according to one or more embodiments. For example, FIG. 14 may be an array diagram of the emission controller EMD illustrated in FIG. 5 and FIG. 8 described above. Further, FIG. 15 is an array diagram in which power lines and clock lines are located in the emission controller EMD of FIG. 14.

The first light emitting transistor M1 may include the gate electrode GE1 connected to the first common clock line CL1, a source electrode SE1 connected to the emission start clock line FLm, and a drain electrode DE1 connected to the emission set node Qm.

The second light emitting transistor M2 may include a gate electrode GE2 connected to the emission low voltage line GLLm, a source electrode SE2 connected to the emission set node Qm, and a drain electrode DE2 connected to the gate electrode GE5 of the fifth light emitting transistor M5.

The third light emitting transistor M3 may include a gate electrode GE31 connected to the gate electrode GE5 of the fifth light emitting transistor M5, a counter gate electrode GE32 connected to the gate electrode GE5 of the fifth light emitting transistor M5, a source electrode SE3 connected to the emission reset node QBm, and a drain electrode DE3 connected to the emission low voltage line GLLm.

The fourth light emitting transistor M4 may include a gate electrode GE4 connected to the emission set node Qm, a source electrode SE4 connected to the emission high voltage line GHLm, and a drain electrode DE4 connected to the emission reset node QBm.

The fifth light emitting transistor M5 may include a gate electrode GE5 connected to the drain electrode DE2 of the second light emitting transistor M2, a source electrode SE5 connected to the emission control line EML, and a drain electrode DE5 connected to the emission low voltage line GLLm.

The sixth light emitting transistor M6 may include a gate electrode GE6 connected to the emission reset node QBm, a source electrode SE6 connected to the emission high voltage line GHLm, and a drain electrode DE6 connected to the emission control line EML.

The seventh light emitting transistor M7 may include a gate electrode GE7 connected to the gate electrode GE5 of the fifth light emitting transistor M5, a source electrode SE7 connected to the emission carry line CRLm, and a drain electrode DE7 connected to the common low voltage line GLL.

The eighth light emitting transistor M8 may include a gate electrode GE8 connected to the emission reset node QBm, a source electrode SE8 connected to the emission high voltage line GHLm, and a drain electrode DE8 connected to the emission carry line CRLm.

The first light emitting capacitor Cm1 may be connected between the emission control line EML and the gate electrode GE5 of the fifth light emitting transistor M5.

The second light emitting capacitor Cm2 may be connected between the emission reset node QBm and the emission high voltage line GHLm.

The emission controller EMD may be connected to the emission high voltage line GHLm, the emission low voltage line GLLm, the common low voltage line GLL, the emission start clock line FLm, the first common clock line CL1, and the second common clock line. The emission high voltage line GHLm, the emission low voltage line GLLm, the common low voltage line GLL, the emission start clock line FLm, and the first common clock line CL1 may overlap the emission controller EMD. For example, the first common clock line CL1 may overlap the seventh light emitting transistor M7, the second-second initialization voltage line VIL22 may overlap the first light emitting transistor M1, the third light emitting transistor M3, the fourth light emitting transistor M4, and the eighth light emitting transistor M8, the common low voltage line GLL may overlap the second light emitting transistor M2, and the emission high voltage line GHLm may overlap the fifth light emitting transistor M5 and the sixth light emitting transistor M6.

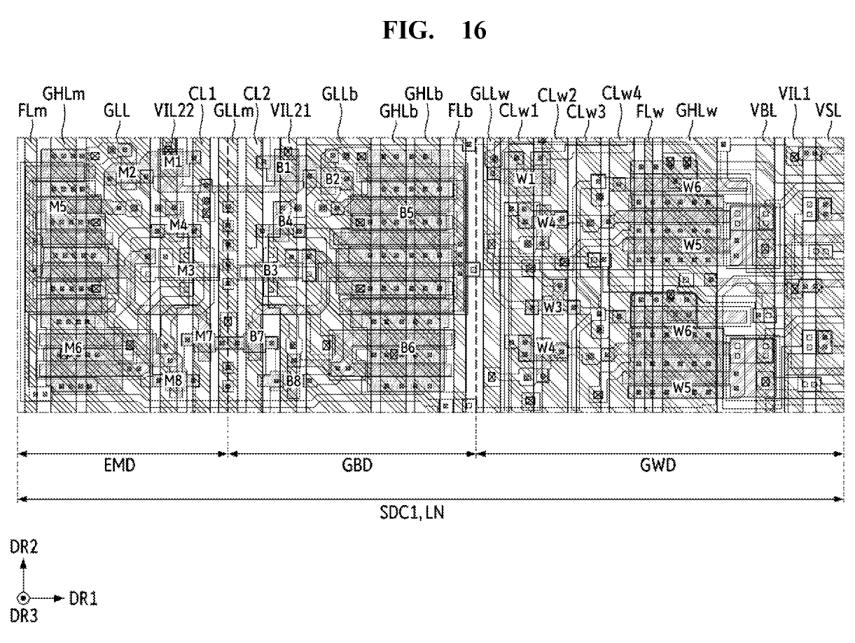

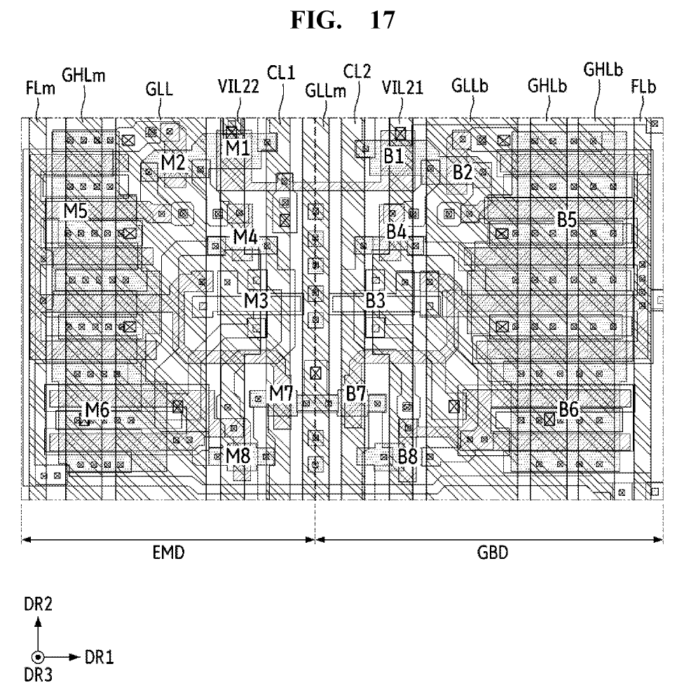

FIG. 16 is an array diagram of the first scan driver SCD1 according to one or more embodiments. For example, FIG. 16 may be a diagram in which the array diagrams of FIGS. 11, 13,and 15, described above are combined. In this case, in FIG. 16, the second write transistor of the first write stage, the fourth write transistor of the third write stage, the fifth transistor of the third write stage, and the sixth write transistor of the third write transistor are omitted. FIG. 17 is an enlarged view of the second gate driver GBD and the emission controller EMD of FIG. 16.

A width LN of the first scan driver SCD1 in the first direction DR1 may be, e.g., 330 µm. Here, the width LN of the first scan driver SCD1 may be the size of the first scan driver SCD1 in the first direction DR1.

According to one or more embodiments, the second-first initialization voltage line VIL21 required for driving the pixel PX may overlap the second gate driver GBD, and the second-second initialization voltage line VIL22 required for driving the pixel PX may overlap the emission controller EMD. In other words, the second-first initialization voltage line VIL21 and the second-second initialization voltage line VIL22 may be located on the second gate driver GBD and the emission controller EMD without overlapping the first gate driver GWD. Accordingly, the width of the first gate driver GWD may be reduced. For example, compared to a structure in which the second-first initialization voltage line VIL21 and the second-second initialization voltage line VIL22 overlap the first gate driver GWD, a structure in which the second-first initialization voltage line VIL21 and the second-second initialization voltage line VIL22 overlap the second gate driver GBD and the emission controller EMD may include the first gate driver GWD having a smaller width.

Because the second gate driver GBD and the emission controller EMD require fewer power lines and clock lines compared to the first gate driver GWD, a free space where the second-first initialization voltage line VIL21 and the second-second initialization voltage line VIL22 may be located may exist in the second gate driver GBD and the emission controller EMD. Therefore, even if the second-first initialization voltage line VIL21 and the second-second initialization voltage line VIL22 are moved from the first gate driver GWD onto the second gate driver GBD and the emission controller EMD, the width of the second gate driver GBD and the width of the emission controller EMD do not increase. Therefore, according to one or more embodiments, the width of the first gate driver GWD may be reduced by the region corresponding to the width of the second-first initialization voltage line VIL21 and the width of the second-second initialization voltage line VIL22 that have moved onto the second gate driver GBD and the emission controller EMD. In other words, the first gate driver GWD may be designed to have a smaller size. For example, as described above, in the first gate driver GWD, the write stages located at the rear end of the first write stage WST1 share the write set node Qw and the write reset node QBw of the first write stage WST1, so that the write stages (e.g., the second write stage WST2 and the third write stage WST3) may be formed to have a size smaller than the size of the first write stage WST1 and, thus, the first gate driver GWD may be formed to have a smaller size. In this way, the width of the first scan driver SDC1 may be reduced as the width of the first gate driver GWD is reduced, so that the width of the non-display area NDA (e.g., the width of the bezel or the width of the dead space) where the first scan driver SDC1 is located may be reduced. Accordingly, not only may the sense of immersion in the screen be increased, but the aesthetic sensibility of the display device 10 may also be improved.

According to one or more embodiments, among the power lines of the pixel, another power line may overlap the second gate driver GBD and the emission controller EMD. For example, at least one of the bias voltage line VBL, the first initialization voltage line VIL1, or the common voltage line VSL of FIG. 9 may overlap the second gate driver GBD and the emission controller EMD. Specifically, the line indicated as "VIL21" in FIG. 9 may be the bias voltage line, the line indicated as "VIL22" may be the first initialization voltage line, the line indicated as "VBL" may be the second-first initialization voltage line, and the line indicated as "VIL1" may be the second-second initialization voltage line. In one or more embodiments, the common voltage line, the second-first initialization voltage line, and the second-second initialization voltage line overlap the first gate driver.

The display device 10 according to the embodiment may be applied to various electronic devices. An electronic device according to one or more embodiments may include the above-described display device 10, and may further include, in addition to the display device 10, a module or device having other additional functions.

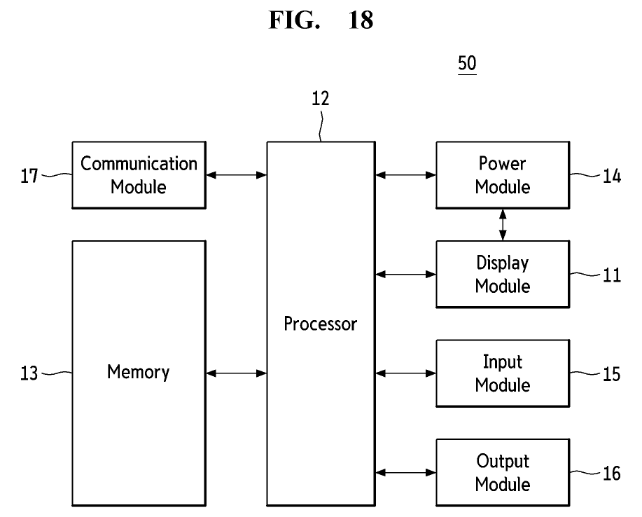

FIG. 18 is a block diagram of an electronic device according to one or more embodiments. Referring to FIG. 18, an electronic device 50 according to one or more embodiments may include a display module 11, a processor 12, a memory 13, and a power module 14. The electronic device 50 may further include an input module 15, a non-visual output module 16, and/or a communication module 17.

The electronic device 50 may output various information in the form of images through the display module 11. When the processor 12 executes an application stored in the memory 13, image information provided by the application may be provided to a user through the display module 11. The power module 14 may include a power supply module, such as a power adapter or a battery device, and a power conversion module that converts the power supplied by the power supply module to generate the power required for the operation of the electronic device 50. The input module 15 may provide input information to the processor 12 and/or the display module 11. The non-visual output module 16 may serve to receive information other than images, such as sound, haptics, luminescence, etc., sent from the processor 12, and provide it to the user. The communication module 17 is a module responsible for the transmission and reception of information between the electronic device 50 and an external device, and may include a receiver and a transmitter.

At least one of the respective components of the electronic device 50 described above may be included in the display device according to the embodiments described above. Further, some of individual modules functionally included in one module may be included in the display device and some others may be provided separately from the display device. For example, the display device may include the display module 11, whereas the processor 12, the memory 13, and the power module 14 may be provided in the form of other devices in the electronic device 50, other than the display device.

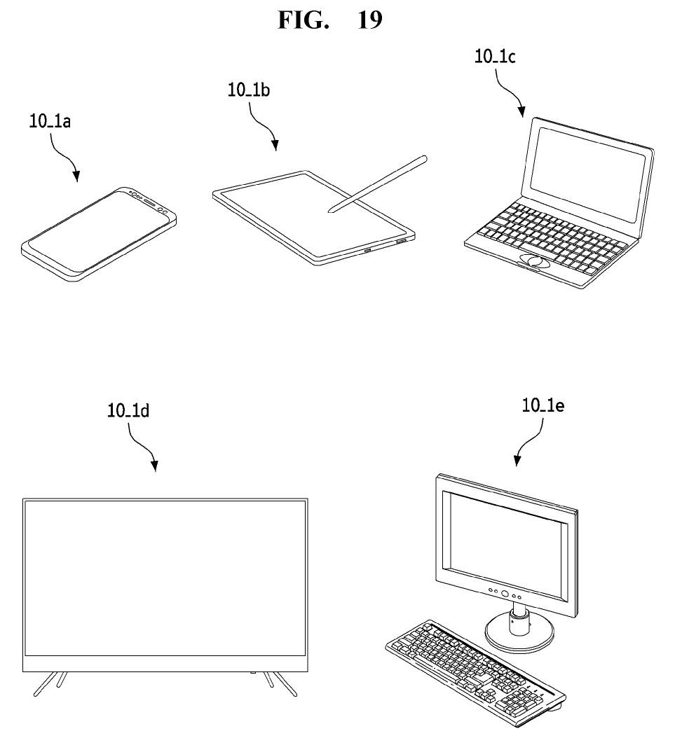

FIGS. 19, 20, and 21 are schematic views illustrating electronic devices according to various embodiments. FIGS. 19 – 21 illustrate examples of various electronic devices to which the display device 10 according to the above-described embodiments are applied.

FIG. 19 shows a smartphone 10_1a, a tablet PC 10_1b, a laptop 10_1c, a TV 10_1d, and a desk monitor 10_1e as examples of electronic devices.

The smartphone 10_1a may include a communication module and an input module such as a touch sensor in addition to the display module 11. The smartphone 10_1a may process the information received through the communication module or input module and display the processed information through the display module of the display device.

Each of the tablet PC 10_1b, the laptop 10_1c, the TV 10_1d, and the desk monitor 10_1e may include a display module and an input module, similar to the smartphone 10_1a, and may further include a communication module in some cases.

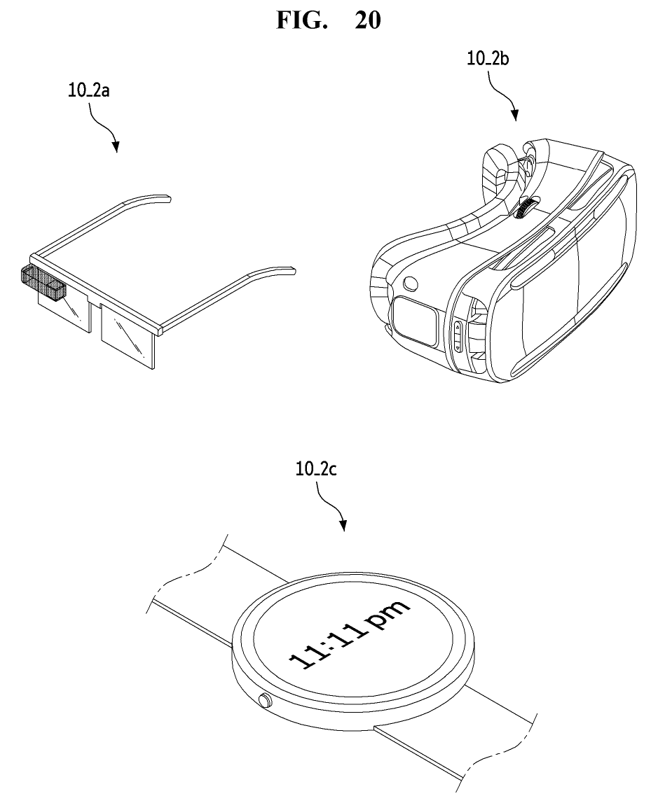

FIG. 20 illustrates a case in which an electronic device including a display module is applied to a wearable electronic device. The wearable electronic device may be smart glasses 10_2a, a head mounted display 10_2b, a smart watch 10_2c, and/or the like.

The smart glasses 10_2a and the head mounted display 10_2b may include a display module that outputs a display image and a reflector that reflects the outputted display image to provide it to the user's eyes, thereby providing the user with a virtual reality or augmented reality screen.

The smart watch 10_2c may include a biometric sensor as an input device, and may provide biometric information recognized through the biometric sensor to the user through a display module.

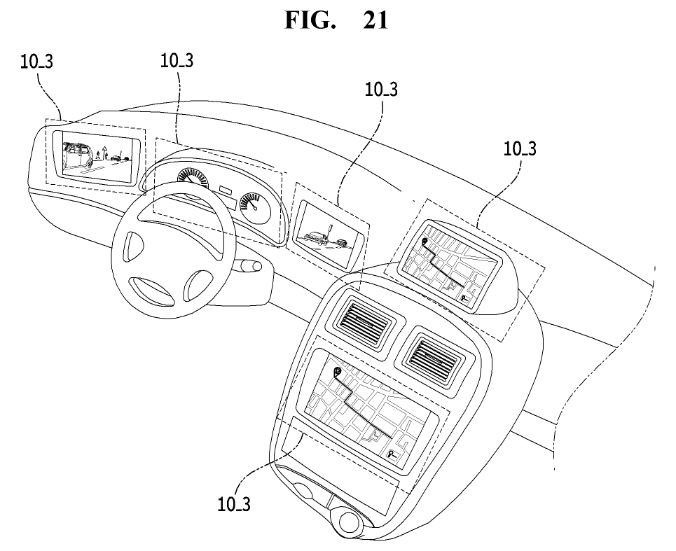

FIG. 21 illustrates a case in which an electronic device including a display module is applied to a vehicle. For example, an electronic device 10_3 may be applied to a dashboard or center fascia of a vehicle, or to a center information display (CID)

placed in the dashboard of the vehicle or a room mirror display that replaces a side mirror.

In concluding the detailed description, those skilled in the art will appreciate that many variations and modifications can be made to the embodiments without substantially departing from the principles and scope of the present disclosure. Therefore, the disclosed embodiments of the present disclosure are used in a generic and descriptive sense only and not for purposes of limitation.

What is claimed is:

1. A display device comprising:
a display panel comprising a display area and a non-display area;
a first gate driver located in the non-display area adjacent to the display area;
an emission controller located in the non-display area adjacent to an edge of the display panel;
a second gate driver located in the non-display area between the first gate driver and the emission controller; and
a plurality of pixel power lines connected to pixels of the display area,
wherein at least one of the plurality of pixel power lines overlaps at least one of the second gate driver or the emission controller.

2. The display device of claim 1, wherein the plurality of pixel power lines comprises a bias voltage line, a first initialization voltage line, a common voltage line, a second-first initialization voltage line, and a second-second initialization voltage line.

3. The display device of claim 2, wherein the second-first initialization voltage line overlaps the second gate driver, and
wherein the second-second initialization voltage line overlaps the emission controller.

4. The display device of claim 3, wherein the bias voltage line, the first initialization voltage line, and the common voltage line overlap the first gate driver.

5. The display device of claim 2, wherein the bias voltage line overlaps the second gate driver, and
wherein the first initialization voltage line overlaps the emission controller.

6. The display device of claim 5, wherein the common voltage line, the second-first initialization voltage line, and the second-second initialization voltage line overlap the first gate driver.

7. The display device of claim 2, wherein a pixel of the pixels of the display area comprises:
a pixel circuit connected to the bias voltage line, the first initialization voltage line, the common voltage line, a data line, and a second initialization voltage line; and
a light emitting element connected to the pixel circuit and the common voltage line,
wherein the second initialization voltage line is one of the second-first initialization voltage line and the second-second initialization voltage line.

8. The display device of claim 7, wherein the pixels of the display area comprise:
a first pixel comprising a first light emitting element to emit first light;
a second pixel comprising a second light emitting element to emit second light; and
a third pixel comprising a third light emitting element to emit third light.

9. The display device of claim 8, wherein the second-first initialization voltage line is connected to the first pixel and the second pixel, and
wherein the second-second initialization voltage line is connected to the third pixel.

10. The display device of claim 9, wherein the first light is light of a red wavelength band,
wherein the second light is light of a blue wavelength band, and
wherein the third light is light of a green wavelength band.

11. The display device of claim 4, further comprising:
a write high voltage line, a write low voltage line, a write start clock line, a first write clock line, a second write clock line, a third write clock line, and a fourth write clock line connected to the first gate driver;
a bias high voltage line, a bias low voltage line, and a bias start clock line connected to the second gate driver;
an emission high voltage line, an emission low voltage line, and an emission start clock line connected to the emission controller; and
a common low voltage line, a first common clock line, and a second common clock line connected to the second gate driver and the emission controller,
wherein the bias start clock line is connected to the second gate driver and the emission controller.

12. The display device of claim 11, wherein the write high voltage line, the write low voltage line, the write start clock line, the first write clock line, the second write clock line, the third write clock line, and the fourth write clock line overlap the first gate driver,
wherein the bias high voltage line, the bias low voltage line, the bias start clock line, and the second common clock line overlap the second gate driver, and
wherein the emission high voltage line, the emission low voltage line, the common low voltage line, the emission start clock line, and the first common clock line overlap the emission controller.

13. The display device of claim 12, wherein the emission low voltage line further overlaps the second gate driver.

14. The display device of claim 12, wherein the second-first initialization voltage line is located between the second common clock line and the bias low voltage line, and
wherein the second-second initialization voltage line is located between the common low voltage line and the first common clock line.

15. The display device of claim 12, wherein the first gate driver comprises a first write stage connected to a first write gate line of the display panel and a second write stage connected to a second write gate line of the display panel,
wherein the first write stage comprises a first write transistor, a second write transistor, a third write transistor, a fourth write transistor, a fifth write transistor, a sixth write transistor, a first write capacitor, and a second write capacitor,
wherein the second write stage comprises a fourth write transistor, a fifth write transistor, a sixth write transistor, a first write capacitor, and a second write capacitor,
wherein the first write transistor of the first write stage comprises a gate electrode connected to the fourth write clock line, a source electrode connected to the write start clock line, and a drain electrode connected to a write set node,
wherein the second write transistor of the first write stage comprises a gate electrode connected to the write set node, a source electrode connected to a write reset node, and a drain electrode connected to the fourth write clock line,
wherein the third write transistor of the first write stage comprises a gate electrode connected to the fourth write clock line, a source electrode connected to the write reset node, and a drain electrode connected to the write low voltage line,
wherein the fourth write transistor of the first write stage comprises a gate electrode connected to the write low voltage line, a source electrode connected to the write set node, and a drain electrode connected to a gate electrode of the fifth write transistor in the first write stage,
wherein the fifth write transistor of the first write stage comprises a gate electrode connected to the drain electrode of the fourth write transistor in the first write stage, a source electrode connected to one of the first to fourth write clock lines, and a drain electrode connected to the first write gate line,
wherein the sixth write transistor of the first write stage comprises a gate electrode connected to the write reset node, a source electrode connected to the write high voltage line, and a drain electrode connected to the first write gate line,
wherein the first write capacitor of the first write stage is connected between the gate electrode of the fifth write transistor in the first write stage and the first write gate line,
wherein the second write capacitor of the first write stage is connected between the write reset node and the write high voltage line,
wherein the fourth write transistor of the second write stage comprises a gate electrode connected to the write low voltage line, a source electrode connected to the write set node, and a drain electrode connected to the gate electrode of the fifth write transistor in the second write stage,
wherein the fifth write transistor of the second write stage comprises a gate electrode connected to the drain electrode of the fourth write transistor in the second write stage, a source electrode connected to another one of the first to fourth write clock lines, and a drain electrode connected to the second write gate line,
wherein the sixth write transistor of the second write stage comprises a gate electrode connected to the write reset node, a source electrode connected to the write high voltage line, and a drain electrode connected to the second write gate line,
wherein the first write capacitor of the second write stage is connected between the gate electrode of the fifth write transistor in the second write stage and the second write gate line, and
wherein the second write capacitor of the second write stage is connected between the write reset node and the write high voltage line.

16. The display device of claim 12, wherein the second gate driver comprises a bias stage connected to a bias gate line of the display panel,
wherein the bias stage comprises a first bias transistor, a second bias transistor, a third bias transistor, a fourth bias transistor, a fifth bias transistor, a sixth bias transistor, a seventh bias transistor, an eighth bias transistor, a first bias capacitor, and a second bias capacitor,
wherein the first bias transistor comprises a gate electrode connected to one of the first common clock line or the second common clock line, a source electrode connected to the bias start clock line, and a drain electrode connected to a bias set node,
wherein the second bias transistor comprises a gate electrode connected to the bias low voltage line, a source electrode connected to the bias set node, and a drain electrode connected to a gate electrode of the fifth bias transistor,
wherein the third bias transistor comprises a gate electrode connected to the gate electrode of the fifth bias transistor, a counter gate electrode connected to the gate electrode of the fifth bias transistor, a source electrode connected to a bias reset node, and a drain electrode connected to the bias low voltage line,
wherein the fourth bias transistor comprises a gate electrode connected to the bias set node, a source electrode connected to the bias high voltage line, and a drain electrode connected to the bias reset node,
wherein the fifth bias transistor comprises the gate electrode connected to the drain electrode of the second bias transistor, a source electrode connected to the bias gate line, and a drain electrode connected to the bias low voltage line,
wherein the sixth bias transistor comprises a gate electrode connected to the bias reset node, a source electrode connected to the bias high voltage line, and a drain electrode connected to the bias gate line,
wherein the seventh bias transistor comprises a gate electrode connected to the gate electrode of the fifth bias transistor, a source electrode connected to a bias carry line, and a drain electrode connected to the common low voltage line,
wherein the eighth bias transistor comprises a gate electrode connected to the bias reset node, a source electrode connected to the bias high voltage line, and a drain electrode connected to the bias carry line,
wherein the first bias capacitor is connected between the gate electrode of the fifth bias transistor and the bias gate line, and
wherein the second bias capacitor is connected between the bias reset node and the bias high voltage line.

17. The display device of claim 12, wherein the emission controller comprises an emission stage connected to an emission control line of the display panel,
wherein the emission stage comprises a first light emitting transistor, a second light emitting transistor, a third light emitting transistor, a fourth light emitting transistor, a fifth light emitting transistor, a sixth light emitting transistor, a seventh light emitting transistor, an eighth light emitting transistor, a first light emitting capacitor, and a second light emitting capacitor,
wherein the first light emitting transistor comprises a gate electrode connected to one of the first common clock line or the second common clock line, a source electrode connected to the emission start clock line, and a drain electrode connected to an emission set node,
wherein the second light emitting transistor comprises a gate electrode connected to the emission low voltage line, a source electrode connected to the emission set node, and a drain electrode connected to a gate electrode of the fifth light emitting transistor,
wherein the third light emitting transistor comprises a gate electrode connected to the gate electrode of the fifth light emitting transistor, a counter gate electrode connected to the gate electrode of the fifth light emitting transistor, a source electrode connected to an emission reset node, and a drain electrode connected to the emission low voltage line,
wherein the fourth light emitting transistor comprises a gate electrode connected to the emission set node, a source electrode connected to the emission high voltage line, and a drain electrode connected to the emission reset node,
wherein the fifth light emitting transistor comprises the gate electrode connected to the drain electrode of the second light emitting transistor, a source electrode connected to the emission control line, and a drain electrode connected to the emission low voltage line,
wherein the sixth light emitting transistor comprises a gate electrode connected to the emission reset node, a source electrode connected to the emission high voltage line, and a drain electrode connected to the emission control line,
wherein the seventh light emitting transistor comprises a gate electrode connected to the gate electrode of the fifth light emitting transistor, a source electrode connected to an emission carry line, and a drain electrode connected to the common low voltage line,
wherein the eighth light emitting transistor comprises a gate electrode connected to the emission reset node, a source electrode connected to the emission high voltage line, and a drain electrode connected to the emission carry line,
wherein the first light emitting capacitor is connected between the gate electrode of the fifth light emitting transistor and the emission control line, and
wherein the second light emitting capacitor is connected between the emission reset node and the emission high voltage line.

18. An electronic device comprising a display device configured to display an image,
wherein the display device comprises:
a display panel comprising a display area and a non-display area;
a first gate driver located in the non-display area adjacent to the display area;
an emission controller located in the non-display area adjacent to an edge of the display panel;
a second gate driver located in the non-display area between the first gate driver and the emission controller; and
a plurality of pixel power lines connected to pixels of the display area,
wherein at least one of the plurality of pixel power lines overlaps at least one of the second gate driver or the emission controller.

19. The electronic device of claim 18, wherein the plurality of pixel power lines comprises a bias voltage line, a first initialization voltage line, a common voltage line, a second-first initialization voltage line, and a second-second initialization voltage line,
wherein the second-first initialization voltage line overlaps the second gate driver, and
wherein the second-second initialization voltage line overlaps the emission controller.

20. The electronic device of claim 18, wherein the electronic device comprises a smartphone, a tablet, a laptop, a television, a desktop monitor, smart glasses, a smart watch, a head mounted display, or a vehicle.
